(19) United States
(12) Patent Application Publication
(10) Pub. No.: US 2013/0253814 A1
(43) Pub. Date: Sep. 26, 2013

(54) System and Method for Gauging Safe Towing Parameters

(71) Applicant: Alvin R. Wirthlin, Allen, TX (US)

(72) Inventor: Alvin R. Wirthlin, Allen, TX (US)

(21) Appl. No.: 13/846,889

(22) Filed: Mar. 18, 2013

Related U.S. Application Data
(63) Continuation-in-part of application No. 13/630,476, filed on Sep. 28, 2012.
(60) Provisional application No. 61/615,211, filed on Mar. 24, 2012.

(51) Int. Cl. G01G 19/02

(52) U.S. Cl. CPC G01G 19/02
USPC 701/124; 701/1

(57) ABSTRACT

A system for determining the tongue weight and total weight of a towed vehicle and other parameters includes a drawbar transducer in one embodiment, a receiver hitch transducer in another embodiment, and a trailer tongue transducer in a further embodiment. Strain gauges are strategically located on the transducer and information regarding the towed vehicle are sent to a display. In one embodiment, a portable display unit, smartphone or the like has a receiver for receiving transmitted data from the transducer reflective of the towed vehicle measured and calculated parameter so that a user can view the tongue weight in practically real time as well as other parameters relating to loading and towing. In this manner, the user can adjust the contents of the towed vehicle to achieve proper tongue weight without the necessity of going back and forth between the trailer and the transducer. A method is also disclosed for determining a safe towing condition based on the trailer tongue weight, trailer pulling force, acceleration during towing, calculated trailer weight, and other factors.

### CROSS-REFERENCE TO RELATED APPLICATIONS

This application claims the benefit of U.S. Provisional Application No. 61/540,196 filed on Sep. 28, 2011, U.S. Provisional Application No. 61/603,247 filed on Feb. 25, 2012, and U.S. Provisional Application No. 61/615,211 filed on Mar. 24, 2012, and claims priority to U.S. application Ser. No. 13/630,476 filed on Sep. 28, 2012, the disclosures of which are hereby incorporated by reference.

### BACKGROUND OF THE INVENTION

This invention relates to measurement devices, and more particularly to a system and method for determining the tongue weight, gross vehicle weight, and other parameters related to the safe towing of a trailer or other towed vehicle.

The tongue weight of a trailer often varies as a trailer is loaded and unloaded. The determination of tongue weight is key to safe transportation practices since all vehicle hitches have a maximum tongue weight limit. However, the determination of tongue weight in the past has been left largely up to guesswork, thereby compromising safety. If for example the weight on the hitch is too small, the trailer may shimmy and sway possibly causing loss of control and an accident or other catastrophic event. If the weight is too high on the hitch, then the rear of the towing vehicle is overloaded and the steering wheels and brakes are less effective, leading to loss of control of the towing vehicle and the inability to stop the towing vehicle and trailer as anticipated.

Various mechanical and electro-mechanical devices for measuring the tongue weight of a trailer have been proposed. Mechanical-type devices typically include a first structural component that rests on the ground or receiver hitch of a towing vehicle, a second structural member that fits in the tongue of a trailer or other towed vehicle, and a biasing member, such as a compression spring, that biases the first and second structural members apart. As a load is applied to the tongue of the trailer, the second structural component will proportionately move with respect to the first structural component. A stationary scale on the first structural component is proportionately hidden or uncovered depending on the tongue weight. However, such as device is has very limited resolution and often functions as a go-no-go gauge, i.e. either the trailer tongue is overloaded or it is not.

Another solution uses the same principle but relies on hydraulic pressure to drive a gauge with a rotating pointer along a stationary scale. Although this solution provides more accuracy, typically in the range of 50 lbf that can be legibly read, the user is still left guessing as to the exact weight of the tongue. In addition, such devices can only be temporarily used during trailer loading. This is inconvenient to most users since it is desirous to hook the trailer up to the towing vehicle prior to loading. Since some objects to be loaded can be quite heavy, such as farm equipment, ATV's, motorcycles, and so on, there is a danger of the trailer tipping rearwardly if it is not properly coupled to the towing vehicle prior to loading. Accordingly, such sensors in and over themselves become an inconvenience. Moreover, even when such a device can be used, it quickly becomes a nuisance for the user to constantly walk back and forth between the device and the trailer to determine if the trailer tongue is at the proper weight.

In addition, trailers are often rented to customers who typically have little towing experience. Such users typically are not familiar with the dangers of overloading and underloading the tongue weight, exceeding the gross rated weight of the trailer, exceeding the recommended towing speed, sudden braking, going too fast around curved sections of the roadway, towing in inclement weather, and so on. Such unsafe towing conditions can lead to trailer mishaps, loss of property, serious injury, and other catastrophic events. It is often difficult to determine whether or not the driver was at fault or if there was a mechanical failure or weather or road conditions, or combinations thereof, that lead the catastrophic event. Accordingly, investigations to determine liability can be quite costly.

Moreover, vehicle manufacturers typically offer bumper-to-bumper warranties for a predetermined time period and/or up to a predetermined mileage limit, subjected to normal driving conditions. However, when the customer drives the vehicle beyond its intended limits during the warranty period, the manufacturer is often left to cover the costs of repair since, in the past, a quantifying method for determining whether the customer or manufacturer is at fault, has been lacking. This is especially problematic for new vehicles with towing packages. In the past, the vehicle manufacturer or authorized dealer has had to rely heavily on the customer's word that the vehicle being towed did not exceed the manufacturer's guidelines for the maximum tongue weight of the trailer or other towed vehicle and/or the towing capacity of the towing vehicle. This problem is exacerbated by the fact that customers do not have the means for determining the trailer tongue weight or the gross vehicle weight rating of the trailer and the manufacturer. Thus, in many instances, the customer may be acting in good faith without realizing that the towing capacity of the vehicle has been greatly exceeded. When such circumstances occur, warranty items such as the engine, transmission, and/or other drive train components, as well as suspension components, may become damaged and in need of repair or replacement, costs which are necessarily covered by the vehicle manufacturer.

It would therefore be desirous to provide a system and method for determining the tongue weight, gross vehicle weight, and other parameters of the towed vehicle in order to quantify whether or not the towing capacity of the towing vehicle has been exceeded.

### BRIEF SUMMARY OF THE INVENTION

According to one aspect of the invention, a drawbar transducer for determining a tongue weight of a towed vehicle includes a coupling section being adapted for connection to a hitch ball for coupling with a trailer tongue, a mounting section being adapted for connection to a hitch of a towing vehicle, and a transducer section located between the coupling section and the mounting section. The transducer section includes a measurement wall having a first thickness, at least one sensor area formed in the measurement wall having a second thickness that is less than the first thickness, and at least one strain sensor located in the sensor area for sensing a load applied to the coupling section.

According to a further aspect of the invention, a system for determining the tongue weight of a towed vehicle includes the drawbar transducer as described above and further includes a portable display unit. The portable display unit has a radio frequency receiver or transceiver for receiving the transmitted data reflective of the applied load on the drawbar transducer, a processor for processing the transmitted data, and a display operably connected to the processor for displaying information related to the tongue weight of a towed vehicle based on the transmitted data.

According to yet a further aspect of the invention, a system for determining the tongue weight of a towed vehicle comprises a transducer body and a display for displaying information related to the tongue weight of a towed vehicle based on the transmitted data. The transducer body has a coupling section adapted for connection to a hitch ball for coupling with a trailer tongue, a mounting section adapted for receipt into a receiver hitch of a towing vehicle, and a transducer section located between the coupling section and the mounting section. The transducer section includes first and second compartments formed in opposite sides of the transducer body to form a measurement wall with a first thickness, first and second sensor areas formed in opposite sides of the measurement wall in the first and second compartments, respectively, the measurement wall having a second thickness at the sensor areas that is less than the first thickness, and at least one strain sensor located in at least one of the first and second sensor areas for sensing a load applied to the coupling section.

In accordance with another aspect of the invention, a receiver hitch system includes a crossbar, a mounting bracket connected at opposite ends of the crossbar for connecting the receiver hitch to a tow vehicle, and a receiver tube extending rearwardly from the crossbar. The receiver tube is adapted for connection to a drawbar to thereby couple a trailer to the tow vehicle. The system also includes a first strain sensor operably associated with the receiver hitch for measuring at least one of a trailer tongue weight and trailer pull force. A processor is operably connected to the first strain sensor for calculating the at least one trailer tongue weight and trailer pull force.

In accordance with yet another aspect of the invention, a strain sensor module includes a sensor mounting plate have a first face and a second face located on an opposite side of the sensor mounting plate, a first recessed sensor area formed in the first face, a second recessed sensor area formed in the second face opposite the first recessed sensor area to thereby create a center web therebetween, a first strain gauge fixedly secured to the center web in the first recessed sensor area, and a second strain gauge fixedly secured to the center web in the second recessed sensor area. A first thickness between the first and second faces is greater than a second thickness of the center web such that shear stresses on the center web is greater than shear stresses on the first and second faces when a load is applied to the strain sensor module.

According to a further aspect of the invention, a receiver hitch system having at least at least one strain sensor module as set forth above includes a crossbar, a mounting bracket connected at opposite ends of the crossbar for connecting the receiver hitch to a tow vehicle, and a receiver tube extending rearwardly from the crossbar for connection to a drawbar to thereby couple a trailer to the tow vehicle. The at least one strain sensor module is located on one of the receiver tube and crossbar for measuring one of a trailer pull force and a trailer tongue weight. A second strain sensor module is located on the other of the receiver tube and crossbar for measuring the other of the trailer pull force and trailer tongue weight.

In accordance with a further embodiment of the invention, a method for determining a safe towing condition of a trailer with respect to a predetermined tow rating of a tow vehicle includes determining a tongue weight of the trailer; pulling the trailer with the tow vehicle; measuring acceleration and pull forces of the trailer during pulling; and determining the weight of the trailer by dividing the pull force by the acceleration multiplying the quotient by a gravitational acceleration. A safe towing condition can be determined when a ratio of the tongue weight to the trailer weight is within a predetermined range.

According to still a further embodiment of the invention, a sensor kit for detecting and analyzing loading and towing conditions of a trailer with respect to a tow vehicle includes a first sensor module having a first force sensor for sensing a pull force of the trailer, and a processing module operably connectable to the first sensor module for receiving first data related to the pull force. The processing module includes means for calculating a weight of the trailer and communicating the weight calculation to a user. The kit can be installed on a receiver hitch, drawbar, trailer tongue, or other load-bearing structure.

According to another embodiment of the invention, a trailer tongue comprises the kit above and further includes a first load bearing member. The first sensor module is securely connected to the first load bearing member along a first plane and the second sensor module is connected to the trailer tongue along a second plane transverse to the first plane.

According to yet another embodiment of the invention, a system for monitoring and calculating loading and towing conditions of a trailer includes means for storing tow vehicle information, means for storing trailer information, means for monitoring trailer tongue weight and total trailer weight during loading and towing, means for comparing the trailer tongue weight and total trailer weight to the stored tow vehicle information and stored trailer information, and means for indicating a safe or unsafe tow condition based on the comparing means.

### BRIEF DESCRIPTION OF THE DRAWINGS

The foregoing summary as well as the following detailed description of the preferred embodiments of the present invention will be best understood when considered in conjunction with the accompanying drawings, wherein like designations denote like elements throughout the drawings, and wherein:

FIG. 1 is a side elevational view of a system for determining the tongue weight and other parameters of a towed vehicle in accordance with the present invention;

FIG. 2 is a rear isometric view of a drawbar transducer connected to the receiver hitch of a vehicle that can form part of the system of FIG. 1;

FIG. 3 is a rear isometric view of the drawbar transducer without the receiver hitch;

FIG. 4 is a rear isometric exploded view of the drawbar transducer in accordance with the invention;

FIG. 5 is a right side elevational view of the drawbar transducer;

FIG. 6 is an enlarged sectional view of the drawbar transducer taken along line 6-6 of FIG. 5;

FIG. 6A is an enlarged left side elevational view of a portion of a sensing section of the drawbar transducer;

FIG. 6B is an enlarged right side elevational view of a portion of the sensing section of the drawbar transducer;

FIG. 7 is an enlarged sectional view of the drawbar transducer taken along line 7-7 of FIG. 5;

FIG. 8 is a rear isometric view of a drawbar transducer for determining the tongue weight of a towed vehicle and other parameters in accordance with a further embodiment of the present invention;

FIG. 9 is a rear isometric exploded view thereof;

FIG. 10 is a left side elevational view of the drawbar transducer of FIG. 8;

FIG. 11 is a sectional view of the drawbar transducer taken along line 11-11 of FIG. 8;

FIG. 12 is a sectional view of the drawbar transducer taken along line 12-12 of FIG. 8;

FIG. 13 is a left side elevational view of the transducer body of the FIG. 8 drawbar transducer;

FIG. 14 is a left side elevational view of a transducer body in accordance with a further embodiment of the invention;

FIG. 15 is a left side elevational view of a transducer body in accordance with another embodiment of the invention;

FIG. 16 is a front isometric view of a drawbar transducer for determining the tongue weight of a towed vehicle and other parameters in accordance with a further embodiment of the present invention connected to the receiver hitch of a vehicle;

FIG. 17 is a front isometric exploded view thereof;

FIG. 18 is an isometric view of a remote display unit for displaying the tongue weight of a towed vehicle;

FIG. 19 is an isometric view of a remote display in accordance with a further embodiment of the invention;

FIG. 20 is a block diagram illustrating major electronic components of the drawbar transducer;

FIG. 21 is a block diagram illustrating major electronic components of the remote display unit;

FIG. 22 is a block diagram illustrating major electronic components of the system for determining the tongue weight, towed vehicle weight, and other parameters of a towed vehicle in accordance with a further embodiment of the invention;

FIG. 23 is an isometric schematic view of a receiver hitch system that can form part of the system of FIG. 1 for determining the tongue weight and other parameters of a towed vehicle in accordance with a further embodiment of the present invention;

FIG. 24 is an isometric exploded view thereof with the drawbar and display being absent;

FIG. 25 is an isometric view of a receiver hitch system in accordance with yet another embodiment of the invention, illustrating various positions where modular strain sensors may be located to measure the tongue weight, towed vehicle weight, and other parameters, with an enlarged strain sensor module for the purpose of more clearly illustrating the invention;

FIG. 25A is a sectional view of the strain sensor module taken along line 25A-25A of FIG. 25;

FIG. 26 is a top plan view of a trailer tongue system in accordance with a further embodiment of the invention, illustrating various positions where modular strain sensors may be located to measure the tongue weight, pulling forces, and other parameters;

FIG. 27 is a rear isometric view of a drawbar system in accordance with another embodiment of the invention, illustrating various positions where modular strain sensors may be located to measure the tongue weight, pulling forces, and other parameters;

FIG. 28 is an isometric view of a sensor kit in accordance with the invention for mounting to a vehicle receiver hitch, a trailer tongue, and/or a drawbar to measure the tongue weight, pulling forces, and other parameters;

FIG. 29 is a sectional view of a strain sensor module taken along line 29-29 of FIG. 26;

FIG. 29A is a sectional view similar to FIG. 29 of a strain sensor module in accordance with a further embodiment of the invention mounted on a structure to be measured;

FIG. 30 is a block diagram of a method for determining a safe towing condition of a trailer or other vehicle to be towed;

FIG. 31 is a block diagram of a method for determining whether or not the tongue weight and trailer weight exceed predetermined weight limits for towing;

FIG. 32 is a block diagram of a method for determining whether or not a top-heavy load condition exists on the trailer or other towed vehicle; and

FIGS. 33-43 illustrate exemplary screen shots of a software system that forms part of the system and method for gauging safe towing conditions.

It is noted that the drawings are intended to depict only typical embodiments of the invention and therefore should not be considered as limiting the scope thereof. It is further noted that the drawings are not necessarily to scale. The invention will now be described in greater detail with reference to the accompanying drawings.

### DETAILED DESCRIPTION OF THE INVENTION

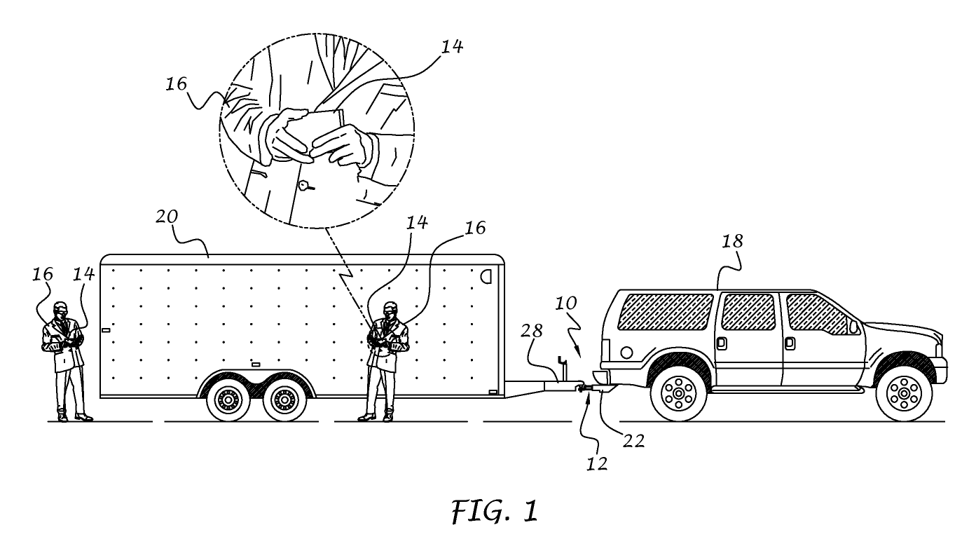

Referring to the drawings, and to FIG. 1 particular, a system 10 for determining the tongue weight of a towed vehicle, as well as other parameters, in accordance with the present invention is illustrated. The system 10 preferably includes a drawbar transducer 12 and a remote display unit 14 which can be carried by a user 16 to remotely read the tongue weight of the towed vehicle, preferably while connected between a towing vehicle 18 and a towed vehicle 20. The wireless transmission of measurement data between the drawbar transducer 12 and display 14 ensures that the user 16 can be located at different locations to monitor the tongue weight as illustrated in FIG. 1 by the different positions of the user 16. In this manner, the loading, unloading and shifting of contents within the towed vehicle can be closely monitored to ensure that the proper tongue weight is obtained for a particular gross vehicle weight rating (GVWR) of the towed vehicle as well as the rated tow capacity of the towing vehicle.

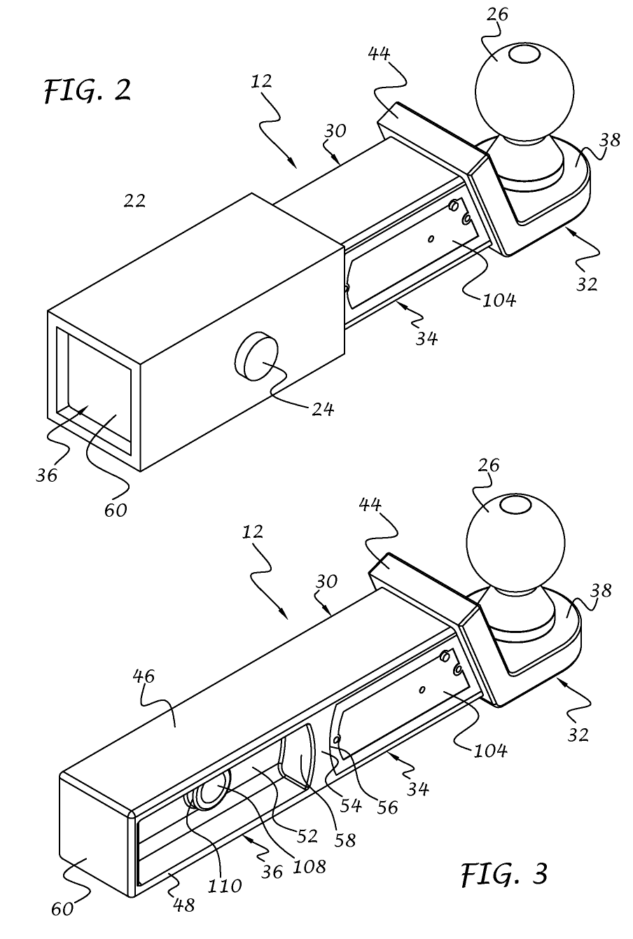

With additional reference to FIG. 2, the drawbar transducer 12 is shown embodied as a hitch bar that is removably mounted in a receiver hitch 22 of the towing vehicle 18 (FIG. 1) via a hitch pin 24 that extends through the receiver hitch 22 and the drawbar transducer. A hitch ball 26 is connectable to the drawbar transducer 12 for coupling the drawbar transducer with the tongue 28 (FIG. 1) of the towed vehicle 20 to thereby connect the vehicles 18, 20 together. When not in use, or when it is desirous to determine the tongue weight of another towed vehicle and/or to use another towing vehicle, the drawbar transducer 12 can be uncoupled from the trailer tongue 28 and removed from the receiver hitch 22 by removing the hitch pin 24 and sliding the drawbar transducer 12 out of the receiver hitch 22.

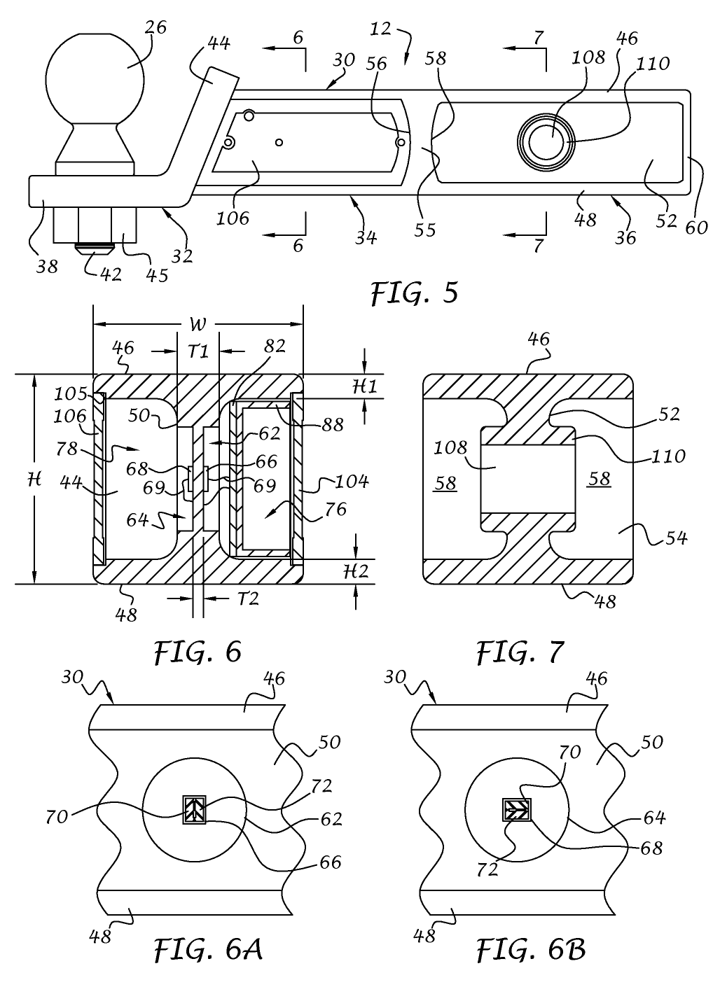

Referring now to FIGS. 3-7, the drawbar transducer 12 preferably includes a transducer body 30 with a forward coupling section 32, an intermediate sensing section 34, and a rear mounting section 36. The forward coupling section 32 preferably includes a platform 38 that extends forwardly from the sensing section 34 and an opening 40 that extends through the platform 38 for receiving the shank 42 of the hitch ball 26 in a well-known manner. A nut 45 (FIG. 5) secures the hitch ball 26 to the platform 38. An inclined wall 44 extends upwardly and rearwardly from the platform 38 to provide clearance for the hitch ball 26 and trailer tongue 28 when coupled to the hitch ball. It will be understood that the coupling section 32 is not limited to a hitch ball arrangement but may be configured to accommodate any coupling requirement of the towed vehicle.

The intermediate sensing section 34 is preferably defined by a top wall 46, bottom wall 48, and a forward upright measurement wall or web 50 that extends centrally between the top and bottom walls to thereby form a generally I-beam shape in cross-section, as shown in FIG. 6.

Likewise, the rear mounting section 36 is preferably defined by the top wall 46, bottom wall 48, and a rearward upright wall or web 52 that extends centrally between the top and bottom walls to form a generally I-beam-shaped cross-section, as shown in FIG. 7. In accordance with an exemplary embodiment of the invention, the width of the top and bottom walls is approximately two inches and the combined height of the upright walls and thickness of the top and bottom walls is approximately two inches so that the rear mounting section 36 can fit within a 2″×2″ Class III or Class IV receiver hitch. However, it will be understood that the drawbar transducer 12 as well as the mounting section 36 can vary in size and configuration to fit different receiver hitch sizes and different towing vehicle hitch types without departing from the spirit and scope of the invention. Moreover, although inclined wall 44 of the coupling section 32 is shown as greater in height and width than the sensing and mounting sections, it will be understood that the inclined wall can be dimensioned to be flush with the top and bottom walls 46 and 48, respectively.

Pillars 54 and 55 preferably extend between the top wall 46 and bottom wall 48 on either side of the transducer body 30 and separate the sensing section 34 from the mounting section 36. The pillars 54 and 55 are located at a longitudinal position along the transducer body 30 to coincide with the position that the transducer body exits the receiver hitch 22 to strengthen the drawbar transducer against bending stress when the trailer tongue 28 (FIG. 1) is coupled to the hitch ball 26. The curved front surface 56 and curved rear surface 58 of the pillars ensure that compressive forces on the front surface and tensile forces on the rear surface are equally distributed along the height of the pillars when the transducer body 30 is under load. The intermediate sensing section 34 is thus bounded by the inclined wall 44 and pillars 54, 55, while the rear mounting section 36 is bounded by the pillars and a rear wall 60 that extends between the top wall 46 and bottom wall 48.

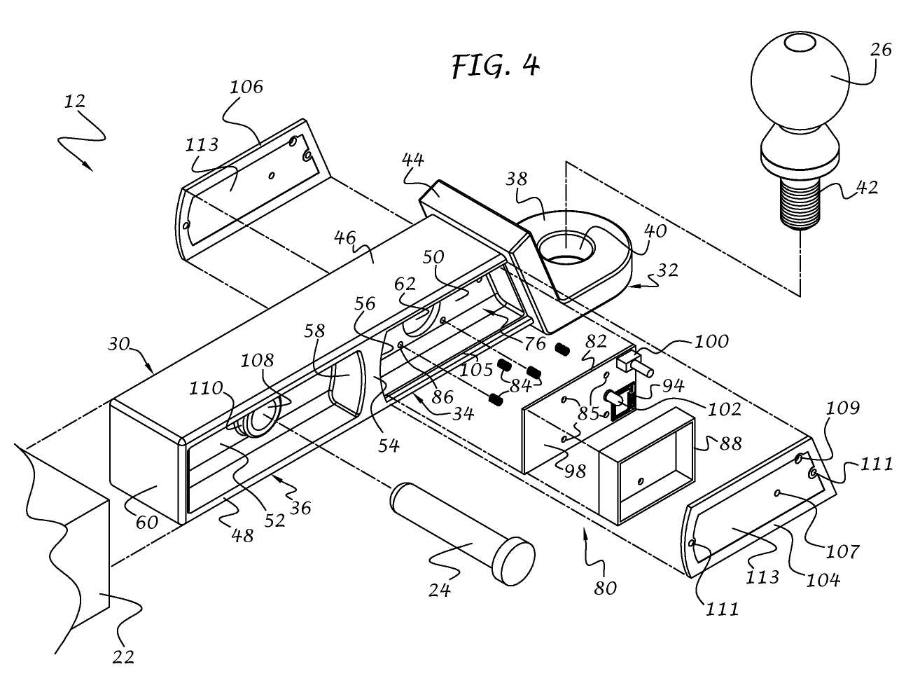

As best shown in FIGS. 4, 6, and 6A and 6B, the upright measurement wall 50 has a first thickness T1 that, together with the upper and lower walls, defines a pair of compartments 76 and 78 on opposite sides of the upright wall 50 for receiving and protecting a sensor electronics section 80, as shown in FIG. 6, besides reducing the amount of material needed to manufacture the drawbar transducer 12.

Recessed sensor areas 62 and 64 are preferably formed in opposite sides of the upright measurement wall 50 in the compartments to create a second thickness T2 which is smaller than the first thickness T1. Strain gauges 66 and 68 are preferably located centrally in the recesses 62 and 64, respectively. Each strain gauge 66, 68 preferably includes dual element strain sensors 70, 72 that are angled at approximately 90 degrees from each other to measure shear stresses in the recesses 62 and 64. Preferably, both of the strain gauges are oriented vertically, or parallel with the strain axis (with the strain sensors 70, 72 angled at 45 degrees with respect to vertical) to sense the shear stresses caused by a vertical load on the hitch ball 26.

In accordance with another preferred embodiment of the invention, one of the strain gauges, such as strain gauge 68, is oriented horizontally, or perpendicular to the strain axis (with the strain sensors 70, 72 angled at 45 degrees with respect to horizontal) to serve as reference sensors, as shown in FIG. 6B.

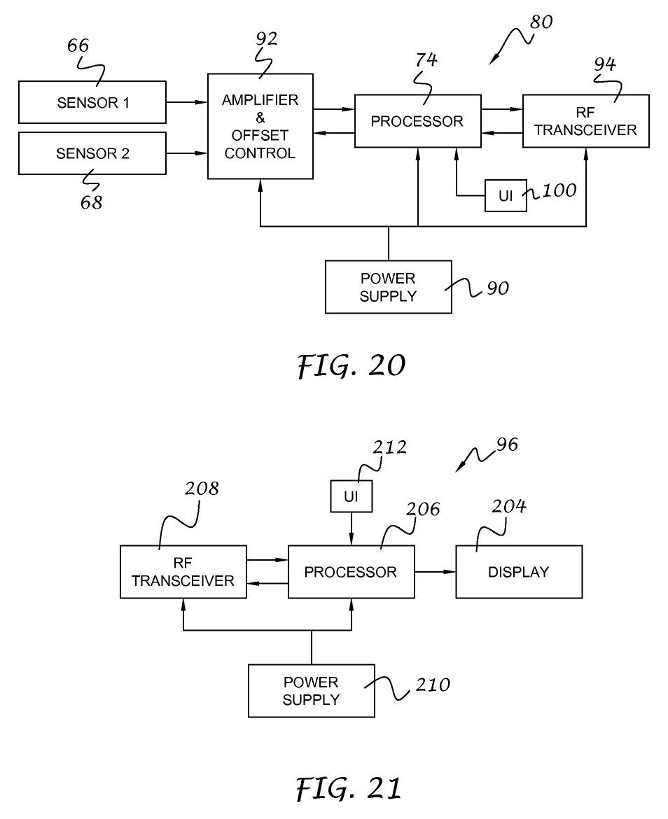

In either embodiment, the sensors 70, 72 of the strain gauges 66, 68 are preferably connected in a bridge circuit (not shown) and sent to a processor 74 (FIG. 20) for determining the vertical force on the hitch ball 26, and thus the tongue weight. The recessed sensor areas 62 and 64 can be filled with a resilient potting material to protect the strain gauges and their delicate wire leads from harsh environmental conditions.

Since, according to the second preferred embodiment, one of the sensors is oriented perpendicular to the shear axis (FIG. 6B) for vertical loads, it is contemplated that fore and aft as well as lateral loads can also be measured. For example, it may be desirous for the operator of a towing vehicle to know if the towing characteristics of the towed vehicle have changed. In this regard, when one or more tires of the towed vehicle experience a loss of air pressure, the average pulling forces on the hitch ball will change over time. This characteristic change can be relayed to the operator for the necessary intervention (see for example the displayed warning 238 in FIG. 19). Moreover, by measuring the fore and/or aft forces during acceleration and/or braking, the weight of the trailer or other towed vehicle can be calculated without the use of a weighing scale. Calculation of the towed vehicle weight will be described in greater detail below. In addition, measuring the fore and aft forces, such as when braking, makes it possible to determine a braking force that can be automatically applied to electrically-operated trailer brakes to prevent jackknifing, delayed stops, and locking of the trailer wheels during hard braking. When the towing vehicle and trailer are parked on an inclined surface, the lateral forces can be used to adjust the measured tongue weight.

The provision of the upright measurement wall with a first thickness T1 and a second thickness T2 that is thinner than the first thickness advantageously ensures that substantially the full measurement range of the strain gauges can be utilized without compromising the integrity of the drawbar transducer 12. Accordingly, greater measurement accuracy over a wide range of vertical loads can be achieved. By way of example, instead of being resigned to an inaccurate reading as much as 20 pounds force (lbf) or more over a range of 0-500 lbf tongue weight in accordance with prior art solutions, an exemplary embodiment of the present invention is capable of displaying a range of 0-1,500 lbf tongue weight in approximately one pound-force (lbf) increments, once properly calibrated, at a cost that is well below highly accurate transducers of different configurations used in other precise measurement applications unrelated to trailer tongue weight measurement.

In accordance with one exemplary embodiment of the invention, and as shown in FIG. 6, the drawbar transducer 12 has a height H of about 2 inches, a width W of about two inches, top and bottom wall thickness H1 and H2 of about 0.235 inch, an upright wall first thickness T1 of about 0.400 inch, an upright wall second thickness T2 of about 0.100 inch created by the recessed sensor areas 62 and 64, and a one-inch diameter recess for the sensor areas 62 and 64. When the drawbar transducer 12 is constructed of an aluminum material, such as AL 6061 or 7075 with a T6 heat treatment, a strain measurement zone in the upright measurement wall 50 of the sensor areas 62 and 64 returned values in the range of zero strain to approximately the maximum safe strain of the strain sensors with stresses well below the yield stress of the material, thereby maximizing the safe measurement bandwidth of the strain gauges without compromising the structural integrity of the drawbar transducer 12. Thus, the provision of an upright measurement wall 50 with the thicker stress bearing area and the thinner strain measurement area ensures measurement accuracy while preserving the integrity of the drawbar transducer 12 under high loads. In addition, the configuration as described and shown provides easy access for mounting the strain gauges on the drawbar transducer and facilitates other assembly requirements.

It will be understood that the various dimensions set forth in the exemplary embodiment can be adjusted depending on the material used for the drawbar transducer 12, the heat treatment properties of the material, the types of strain gauges used, the maximum tongue weight to be measured, the size of the receiver hitch 22, and so on. For example, since carbon steel generally has greater yield strength than many aluminum materials, the thickness T2 of the upright wall 50 may be less for a drawbar transducer made of steel than aluminum in order to obtain the same measurement bandwidth over the same load range. Conversely, when it is desired to determine a greater tongue weight than mentioned in the exemplary embodiment, the thickness T2 of the upright wall 50 may be greater in order to maintain the same measurement bandwidth. In addition, it will be understood that the sensor areas 62 and 64 are not limited by circular recesses but may embody other shapes such as square, triangular, hexagonal, and so on (see for example FIG. 15). It will be further understood that a single sensor area can be formed in the upright wall and/or only one strain gauge or strain sensor can be used in conjunction with other compensating electronics to determine the trailer tongue weight without departing from the spirit and scope of the invention.

As shown in FIGS. 2, 4 and 6, the sensor electronics section 80 preferably includes a printed circuit board (PCB) 82 mounted in the compartment 76 of the sensing section 34. Resilient spacers or stand-offs 84 extend between the PCB 82 and the upright wall 50 to isolate the PCB from stresses that may otherwise be induced by the transducer body 30 under an applied load from the trailer tongue 24 (FIG. 1). In accordance with one embodiment of the invention, the spacers comprise compression springs. However, it will be understood that any resilient or semi-rigid stand-off can be used that isolates the PCB from the transducer body 30. Fasteners (not shown) preferably extend through holes 85 in the PCB 82, the spacers 84, and into threaded apertures 86 formed in the wall 50 to mound the PCB 82 to the wall 50. A small opening (not shown) is formed in the upright wall 50 so that electrical conductors 69 (FIG. 6) from the strain sensor 68 can pass through the wall 50 for connection to the PCB 82. A battery holder 88 is preferably electrically connected to the PCB and is of minimal height to fit within the compartment 76. Batteries (not shown) can be loaded into the battery holder to function as a power supply 90 (FIG. 20) for powering the electronics. Although the PCB has been shown mounted on the left side of the transducer body 30, it will be understood that the PCB can be mounted on either side.

With additional reference to FIG. 20, other components on the PCB preferably include amplifier and offset control circuitry 92 that interfaces between the processor 74 and strain gauges 66, 68 for conditioning the signals from the sensors prior to being received and processed within the processor 74. It will be understood that the amplifier and offset control circuitry 92 may alternatively form part of the processor software or may be eliminated without departing from the spirit and scope of the invention. A radio frequency (RF) transceiver 94 is also connected to the processor 74 for sending signals to the display electronics section 96 (FIG. 21) of the remote display unit 14 (FIGS. 1, 18 and 19) indicative of the tongue weight as determined by the sensor electronics section 80. The transceiver 94 can also receive signals from the remote display unit 14 for initiating various functions such as remotely turning on and off the sensor electronics section 80, verifying the receipt of transmitted information, and so on.

As shown in FIG. 4, the RF transceiver 94 is preferably located on the outward face 98 of the PCB and is spaced from the walls 50, 44, 46, and 48 of the transducer body 30 to minimize RF interference and maximize the distance over which the signals can be transmitted. A user input, such as push-button switch 100 (see also FIG. 20), is also mounted on the outward face 98 of the PCB 82 and extends outwardly for manipulation by a user to selectively turn on and off the drawbar transducer as well as other functions, including but not limited to, entering a learn mode to couple the drawbar transducer 12 with a particular remote display unit 14, entering a tare function to zero out the currently determined tongue weight, and so on. A light source 102, such as a LED, can be provided for indicating the different operational modes of the sensor electronics section 80 by employing different flash rates and/or colors for each mode. The transceiver 94 can also receive signals from the remote display unit 14 for initiating various functions such as remotely turning on and off the sensor electronics section 80, verifying the receipt of transmitted data, and so on.

Covers 104 and 106 are preferably positioned over the compartments 76 and 78 (FIG. 6), respectively, to enclose the sensor electronics section 80, including the strain gauges 66 and 68. Preferably, the covers 104, 106 fit within a depression 105 that surrounds each compartment 76, 78 so that the covers are flush with the upper and lower walls 46, 48. One or both covers can be removable for accessing the electronics section, including the battery holder 88 to replace the batteries when disposable batteries are used. The covers are preferably constructed of plastic or other material that is transparent to RF waves so that RF interference is minimized. An aperture 107 in the cover 104 is aligned with the LED 102 for indicating to a user when the drawbar transducer 12 is in operation. An aperture 109 in the cover is aligned with the switch 100 so that the switch is accessible to a user. Other openings 111 formed in the cover are for mounting the cover to the drawbar via fasteners or the like. A depression 113 formed in the cover is adapted for receiving a user warning label or the like. In order to reduce costs, the covers 104, 106 can be similar in construction, with or without one or more of the apertures and openings.

Referring now to FIGS. 3 and 7, the rear mounting section 36 preferably includes a hole 108 that extends through the rear upright wall 52 for receiving the hitch pin 24. An annular boss or collar 110 is concentric with the hole 108 and extends laterally outwardly from both sides of the upright wall 52 for reinforcing the area surrounding the hole 108.

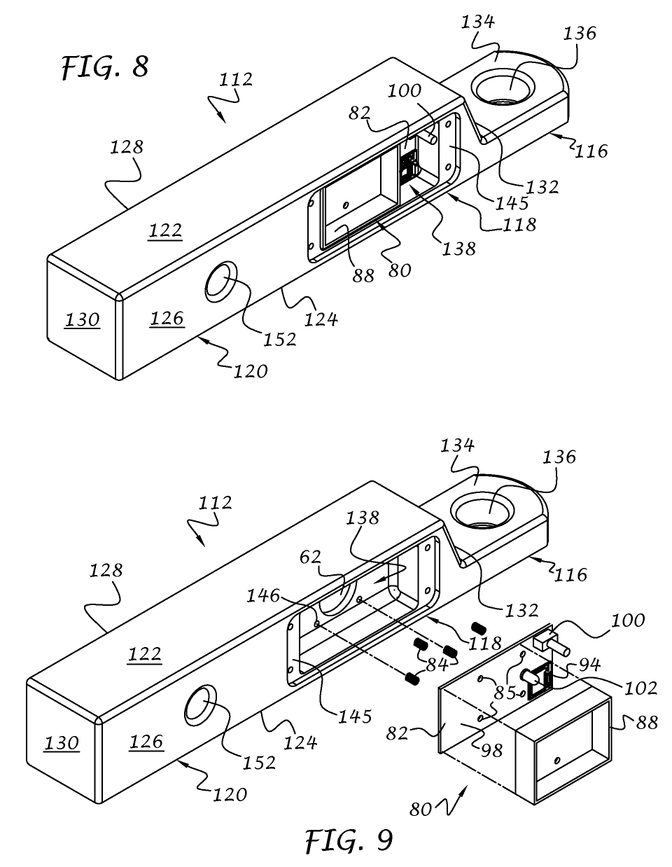

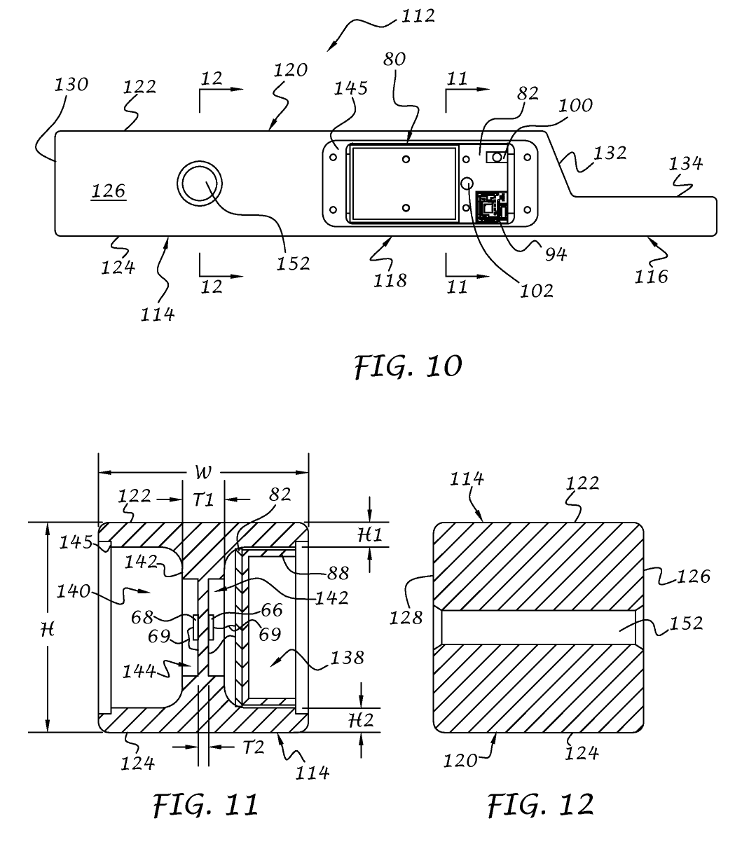

Turning now to FIGS. 8-12, a drawbar transducer 112 in accordance with a further embodiment of the invention is illustrated. The drawbar transducer 112 is somewhat similar in construction to the drawbar transducer 12 previously described, and preferably includes a transducer body 114 with a forward coupling section 116, an intermediate sensing section 118, and a rear mounting section 120. The transducer body 114 is preferably machined from a single block of material, such as aluminum or steel, and includes a top surface 122, a bottom surface 124, a left side surface 126, a right side surface 128, a rear surface 130, and a front inclined surface 132. However, it will be understood that the transducer body 114 can be formed by die-casting, sand casting, or any known forming means without departing from the spirit and scope of the invention.

In accordance with an exemplary embodiment of the invention, the width between the surfaces 126 and 128 and the height between the surfaces 122 and 124 are each approximately two inches so that the rear mounting section 120 can fit within a 2″×2″ Class III or Class IV receiver hitch. However, it will be understood that the width and height of the drawbar transducer 112 as well as the particular shape or configuration can vary to fit different receiver hitch sizes and/or different hitch requirements of the towing vehicle without departing from the spirit and scope of the invention.

The forward coupling section 116 preferably includes a platform 134 that extends forwardly from the sensing section 118 and an opening 136 that extends through the platform 134 for receiving the shank 42 of the hitch ball 26 (FIG. 5) in a well-known manner. The inclined surface 132 extends upwardly and rearwardly from the platform 134 to provide clearance for the hitch ball 26 and trailer tongue 28 when coupled to the hitch ball. As in the previous embodiment, the coupling section 116 can be configured to accommodate any coupling requirement of the towed vehicle.

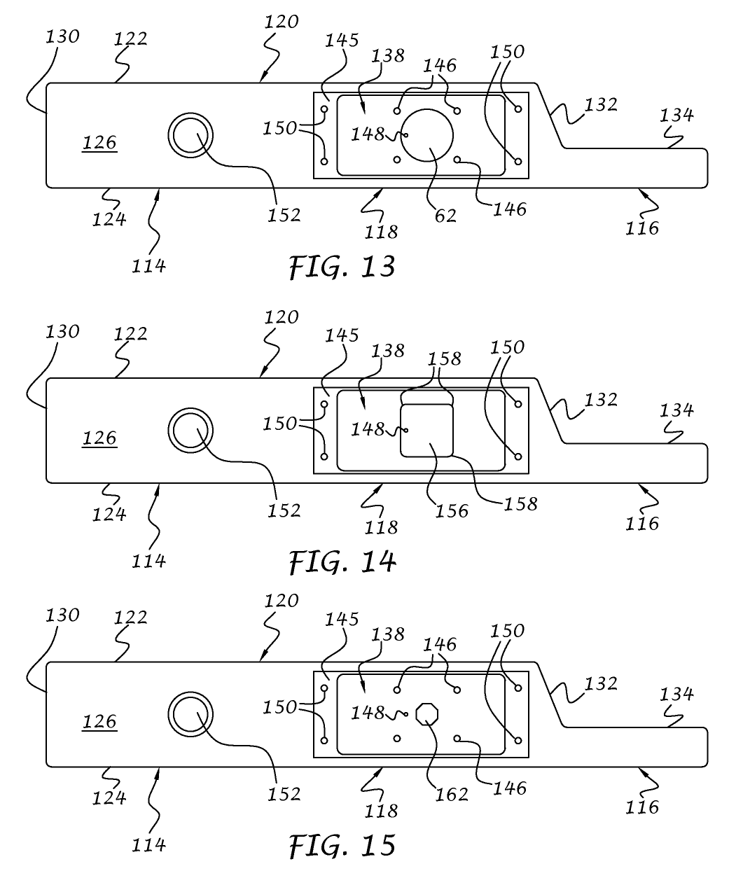

The intermediate sensing section 118 is preferably similar in construction to the sensing section 34 previously described, and includes a first compartment 138 formed in the wall 126 and a second compartment 140 formed in the wall 128 opposite the first compartment for receiving and protecting sensor electronics section 80, as shown in FIGS. 8-11, besides reducing the amount of material needed to manufacture the drawbar transducer 112. An upright measurement wall or web 142 with a first thickness T1 preferably extends centrally between the first and second compartments to form a generally I-beam shape in cross-section, as shown in FIG. 11. Recessed sensor areas 142 and 144 are preferably formed in opposite sides of the upright measurement wall 142 in the compartments 138 and 140, respectively, to create a second thickness T2 which is thinner than the first thickness T1. Strain gauges 66 and 68 are preferably located centrally in the recesses 142 and 144, respectively, as in the previous embodiment. A depression 145 is preferably formed in each side wall 126, 128 surrounding each cavity for receiving a cover (not shown for clarity), such as cover 104, 106 (FIG. 4 of the previous embodiment) to hermetically seal the cavities, and thus the electronics section, from environmental conditions. Threaded apertures 150 (FIG. 13) can be provided for receiving fasteners (not shown) that extend through the covers for removably connecting one or both covers to the drawbar transducer 112.

As shown in FIG. 13, each recessed area is preferably circular in shape and extends across a substantial height of the upright measurement wall 142 within each compartment. Threaded apertures 146 can be formed in the upright wall 142 for receiving fasteners (not shown) to mount the PCB 82 (FIG. 9) within the compartment 138, although the PCB can alternatively be mounted in the compartment 140. A small opening 148 is formed in the upright wall 142 so that electrical conductors 69 (FIG. 11) from the strain sensor 68 can pass through the wall 142 for connection to the PCB 82 (FIG. 11).

As best shown in FIGS. 8, 9 and 12, the rear mounting section 120 is preferably solid in construction with the exception of a hole 152 that extends through the transducer body 114 between the side surfaces 126 and 138 for receiving a hitch pin, such as hitch pin 24 shown in FIG. 4, for securing the drawbar transducer 112 to the receiver hitch of a vehicle.

Turning now to FIG. 14, a drawbar transducer body 154 in accordance with a further embodiment of the invention is illustrated. The transducer body 154 is similar in construction to the transducer body 114 previously described, with the exception that the recessed sensor area 156 on one or both sides of the transducer body 154 is of a generally square shape. The corners 158 of the sensor area 156 are preferably rounded to distribute stress more uniformly thereby avoiding high stress points.

Turning now to FIG. 15, a drawbar transducer body 160 in accordance with a further embodiment of the invention is illustrated. The transducer body 160 is similar in construction to the transducer body 114 previously described, with the exception that the recessed sensor area 162 on one or both sides of the transducer body 160 is generally of an octagonal shape and is much smaller in area than the sensor areas of the previous embodiments.

Accordingly, it will be understood that one or more recesses for receiving one or more strain sensors for sensing the weight of a trailer tongue can be of different shapes and sizes without departing from the spirit and scope of the invention.

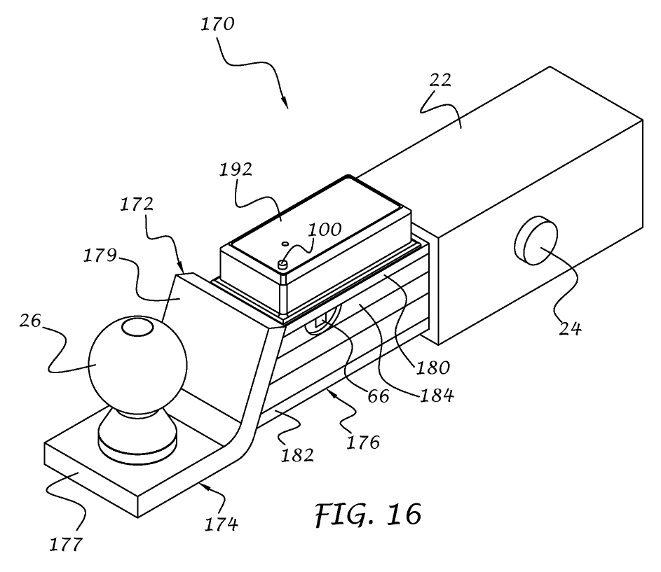

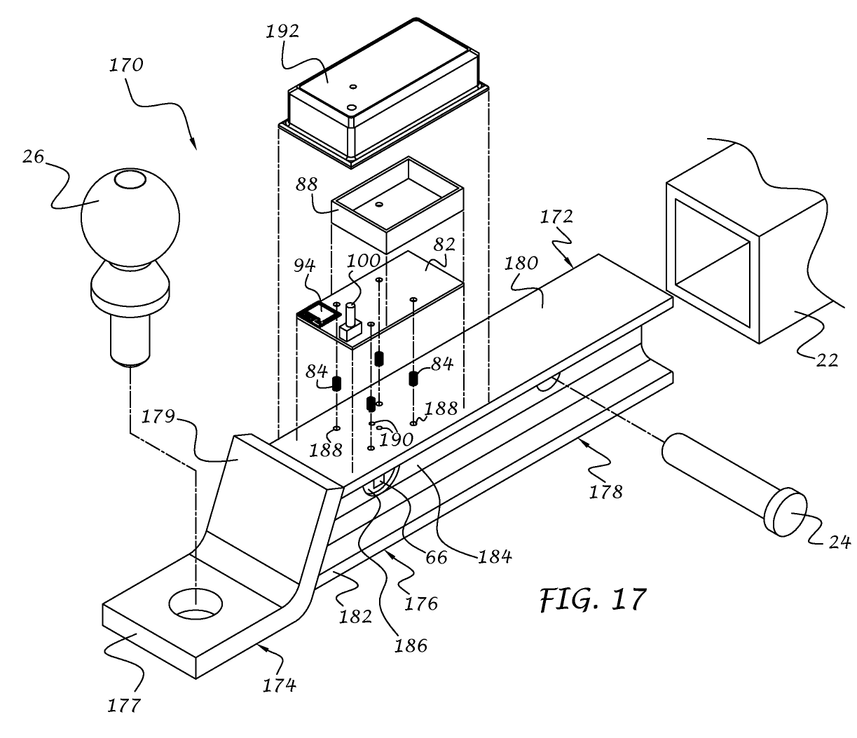

Referring now to FIGS. 16 and 17, a drawbar transducer 170 in accordance with a further embodiment of the invention is illustrated. The drawbar transducer 170 is somewhat similar in construction to the drawbar transducer 12 previously described, and preferably includes a transducer body 172 with a forward coupling section 174, an intermediate sensing section 176, and a rear mounting section 178. The transducer body 172, including the sensing section 176 and the mounting section 178 is preferably extruded, such as out of aluminum or steel, into the shape of an I-Beam while the forward coupling section 174 is preferably bent from a metal plate, such as aluminum or steel, and welded to the sensing section 176 to form a platform 177 for supporting a hitch ball 26 and an inclined wall 179 as in the previous embodiments.

The intermediate sensing section 176 and rear mounting section 178 are preferably defined by a top wall 180, bottom wall 182, and an upright measurement wall or web 184 that extends centrally between the top and bottom walls to form a generally I-beam shape in cross-section. In accordance with an exemplary embodiment of the invention, the width of the top and bottom walls is approximately two inches and the combined height of the upright walls and thickness of the top and bottom walls is approximately two inches so that the rear mounting section 178 can fit within a 2″×2″ Class III or Class IV receiver hitch 22. However, it will be understood that the width and height of the drawbar transducer 170 can vary to fit different receiver hitch sizes without departing from the spirit and scope of the invention. Moreover, although inclined wall 179 of the coupling section 174 is shown as greater in height and width than the sensing and mounting sections, it will be understood that the inclined wall can be dimensioned to be flush with the top and bottom walls 180 and 182, respectively.

Recessed sensor areas 186 (only one shown) are preferably formed in opposite sides of the upright measurement wall 184 in the compartments to create a second thickness which is thinner than a first thickness of the upright measurement wall, as in the previous embodiments. Strain gauges 66 (only one shown) are preferably located centrally in the recessed sensor areas 186. As shown, each recessed area is preferably circular in shape and extends across a substantial height of the upright measurement wall 184 within each compartment.

The sensor electronic section 80 is preferably connected to the top wall 180 via fasteners (not shown) that extend through holes 85 in the PCB 82, the resilient spacers 84, and into threaded apertures 188 formed in the top wall 180 to mount the PCB 82 to the top wall. Small openings 190 are formed in the top wall 180 so that electrical conductors (not shown) from the strain sensors 66 can pass through the top wall for connection to the PCB 82. A removable cover 192 is also preferably connected to the top wall 180 and surrounds the electronics section 80 for protecting the electronics section from the outside environment. It will be understood that the electronics section 80 and cover 192 can be connected to the bottom wall 182 or upright wall 184 without departing from the spirit and scope of the invention.

The rear mounting section 178 preferably includes a hole 194 that extends through the upright wall 184 for receiving a hitch pin, such as hitch pin 24, for securing the drawbar transducer 170 to the receiver hitch 22 of a vehicle.

Although a power supply in the form of one or more batteries is preferred in each of the above drawbar transducer embodiments for portability and interchangeability of the drawbar transducer, the power supply can additionally or alternatively be provided by the towing vehicle's electrical trailer hook-up in accordance with a further embodiment of the invention. Accordingly, an electrical cable with appropriate terminations (not shown) can be provided to supply power to the sensor electronics section 80. The provision of electrical power from the towing vehicle can be especially advantageous when it is desirous to monitor the trailer tongue weight and other parameters during actual towing. When vehicle power supply is used, the electronics section 80 can include components and circuitry to protect the electronics section from electrical spikes, back-EMF, and other electrical anomalies commonly associated with vehicles and other equipment.

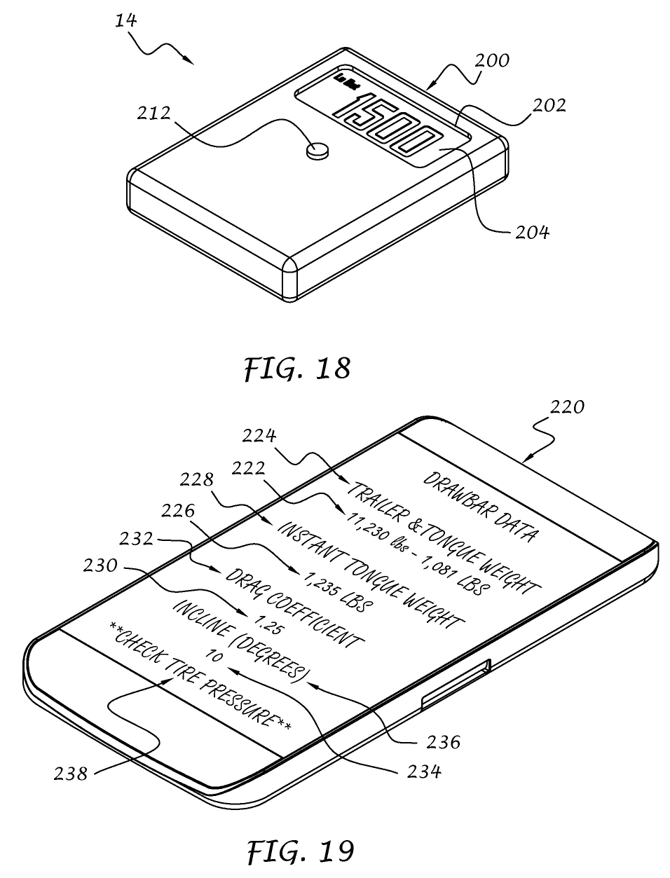

Referring now to FIGS. 18 and 21, the remote display unit 14 preferably includes a housing 200 for holding the display electronics section 96 (FIG. 21). A window 202 is formed in the housing 200 for exposing a display 204 that is in turn connected to a processor 206. A RF transceiver 208 is preferably connected to the processor 206 for receiving measurement signals from one or more load bar transducers previously described. A power supply 210 is connected to the processor 206 and transceiver 208. Preferably, the power supply comprises one or more batteries so that the remote display unit 14 has portability. A user input, such as push-button switch 212, preferably extends outwardly from the housing 200 for manipulation by a user to selectively turn on and off the display 14 as well as to select other functions, including but not limited to, entering a learn mode to couple the remote display unit 14 with a particular drawbar transducer, entering a tare function to zero out the currently determined tongue weight, and so on.

The provision of a remote display that can be carried by a user, as shown in FIG. 1, is especially advantageous over prior art solutions that require the user to be next to the tongue of the trailer to determine its weight. The remote display of the present invention allows the user to be located at different locations to monitor the tongue weight so that loading, unloading and shifting of contents on or within the towed vehicle can be closely monitored without the necessity of going back and forth between the tongue and main body of the trailer so that the proper tongue weight can be obtained in practically real time. Such a provision also allows a user to constantly monitor the tongue weight and other parameters during an actual towing operation, such as determining if the load has shifted, whether or not one or more of the tires of the towed vehicle has lost pressure, and so on.

Referring now to FIG. 19, a remote display unit 220 in accordance with a further embodiment of the invention is preferably embodied as a smartphone or tablet that can communicate via Bluetooth™ technology or other wireless transmission systems and/or frequencies with the drawbar transducer. The remote display unit 220 preferably includes additional display items so that the condition of the load and/or changes in the load condition can be monitored during loading and towing.

By way of example, the actual trailer tongue weight 222 as well as the trailer weight (as will be described in greater detail below) can be displayed below the designation 224. Likewise, the instantaneous tongue weight 226 and trailer weight can be displayed below the designation 228. The instantaneous tongue weight and trailer weight may be especially important prior to towing and during towing to determine actual load on the hitch system that may occur when the towing vehicle and towed vehicle pass over bumps or other anomalies in the road surface. A drag coefficient or the like 230 can be displayed under a suitable heading 232. A drag force can be measured for example when the towing vehicle and towed vehicle are climbing or descending a hill (such as an incline measurement 234 under a suitable heading 136), during braking, wind resistance in various direction and at different speeds, and so on. Information about drag can be measured from lateral as well as fore and aft forces acting on the hitch ball as measured by the drawbar transducer. With such measured forces, it can be determined whether one or more of the above factors may be causing the drag and to what extent under normal operating conditions. If the drag is too high or too low for such conditions, then it may be determined that the tire pressure is too high to too low, as well as other mechanical conditions that might cause concern to the user. Warning messages, such as message 238, can be provided on the smart phone 220, vehicle display, or the like to alert an operator of possible problems that may need to be resolved. An understanding of what is happening to the hitch system as well as the towing vehicle and towed vehicle in real time can improve driver performance and potentially avoid catastrophic events. Such data can be gathered and processed through known data processing techniques using computer algorithms or software for various platforms and can be provided as computer readable software on various media storage devices for downloading into and operating on the smartphone, a computer, display, or the like, including but not limited to, hard drives, Internet websites, thumb drives, flash memory devices, CD's, and so on. In addition, such data can be used to determine the braking force of a towing vehicle and automatically adjust the brakes of the trailer to avoiding trailer wheel locking and its attendant consequences while maximizing braking force in the towed vehicle.

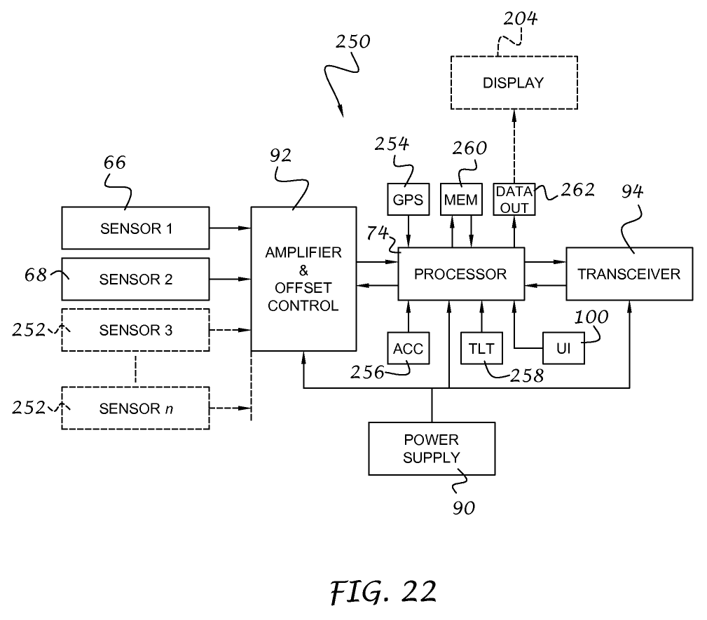

Turning now to FIG. 22, a sensor electronics section 250 in accordance with a further embodiment of the invention is illustrated. The sensor electronics section 250 is somewhat similar to the sensor electronics section previously described, with the addition of other electronic components. By way of example, a third strain sensor 252, representative of one or more additional strain sensors, can be installed on the drawbar transducer at various locations and angles to measure fore and aft forces as well as lateral forces. A GPS unit 254 is also preferably provided to determine instantaneous velocity as well as the location of the towed vehicle at all times but more importantly during a potential catastrophic event so that the cause of the catastrophic event can be determined, whether it be driver error, mechanical error, and/or events beyond the control of the driver. An accelerometer 256 is also preferably provided to determine acceleration, deceleration, instantaneous velocity, centrifugal forces experienced while turning and/or towing through curved sections of a roadway, the weight of the towed vehicle, and so on. In this manner, automatic braking forces can be applied to the trailer brakes during a deceleration even as discussed above. In addition, the accelerometer can be used in conjunction with location and speed data from the GPS to determine if a user has exceeded the recommended safe highway speed for the towed trailer as well as excessive speeds around curved road segments in case of a catastrophic event.

A tilt sensor 258 can also be provided to determine if the towed vehicle is climbing or descending a hill and/or parked on a hill to more accurately determine and display the trailer tongue weight, trailer weight, as well as changes in drag that may occur as discussed above. The data gathered from the various sensors can be stored in a memory 260 associated with the processor 74 and a data output interface 262 can be provided in order to store, process and display the recorded data on a display, such as display 204 (shown in broken line) associated with a computer or other electronics device, or the like. This is especially advantageous for trailer rental companies whose customers have little or no experience with towing, not only to help the customer load the trailer properly, but to also monitor one or more of the various parameters as discussed above for operator safety and liability determination when a catastrophic event has occurred.

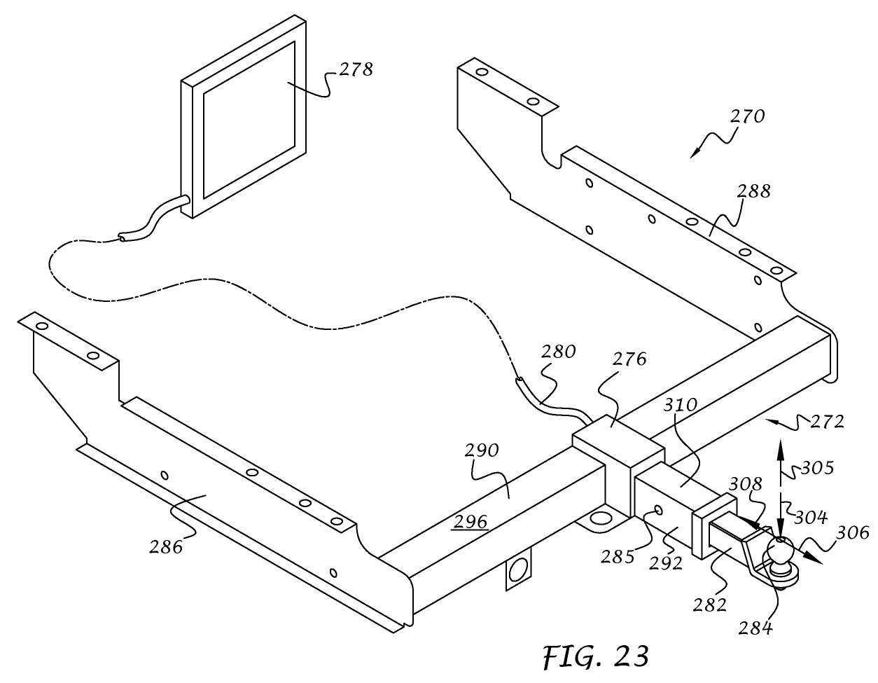

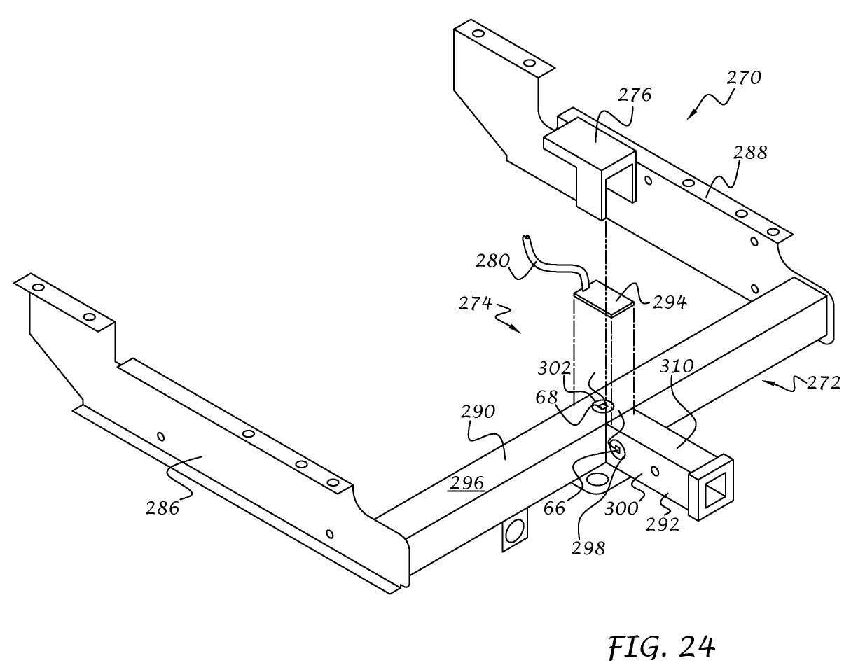

Referring now to FIGS. 23 and 24, a receiver hitch system 270 for determining various parameters of a towed vehicle is schematically illustrated. The system 270 preferably includes a receiver hitch 272, an electronics section 274 connected to the receiver hitch, a housing 276 for securing and protecting the electronics section, and a display 278 operably connected to the electronics section 274. The display 278 can be hard-wired to the electronics section, such as through a power and/or signal cable 280, or wirelessly connected thereto in a manner as previously described with respect to the prior exemplary embodiments of the invention. Power to the electronics section is preferably provided by the towing vehicle via the cable 280 since the receiver hitch is mounted on the vehicle as a permanent or semi-permanent accessory thereof, but can alternatively be provided by a separate power supply such as one or more batteries, solar cells, and so on.

The receiver hitch 272 is adapted for installation on a vehicle, such as a towing vehicle 18 shown in FIG. 1, and is adapted to receive a drawbar 282 with an installed hitch ball 284 for coupling to the tongue 28 (FIG. 1) of a trailer 20 or other vehicle adapted for towing. A hitch pin 285 extends through the drawbar 282 and receiver hitch 272 for securing the drawbar to the hitch in a well-known manner. Although the drawbar 282 may be similar in construction to the drawbar transducers of the previous embodiments, a prior art drawbar that fits within the receiver opening can be used since the electronics for measuring and determining various parameters of the towed vehicle, such as the parameters previously described, are associated with the receiver hitch 272 in accordance with the present embodiment of the invention.

The receiver hitch 272 preferably includes a left mounting bracket 286 and a right mounting bracket 288 configured for attachment to the frame or chassis of a towing vehicle in a well-known manner, a crossbar 290 extending laterally between the mounting brackets 286 and 288, and a receiver tube 292 extending rearwardly from the crossbar 290 for receiving the drawbar 282. The receiver tube 282 can be fixedly attached to the crossbar 290 by connection means such as, for example, welding, threaded fasteners, and so on. Similarly, the mounting brackets 286 and 288 can be attached to the crossbar 290 by the same connection means at the opposite ends of the crossbar 290. Although the crossbar 290 is shown as a single tubular member that extends between the mounting brackets 286, 288 for simplifying the description of the invention, it will be understood that the crossbar 290 can be constructed of multiple pieces, of solid or hollow construction, straight or bent, and have various cross sectional shapes without departing from the spirit and scope of the invention. It will be further understood that, due to the wide variety of vehicles capable of towing, the mounting brackets 286 and 288 can be of various configurations. Thus, the present invention is not limited to any particular receiver hitch configuration. Moreover, the present invention can be applied to other hitch configurations, such as bumper-mounted hitches, gooseneck hitches, fifth-wheel hitches, front-mounted hitches, and so on.

The electronics section 274 preferably includes a printed circuit board (PCB) 294 with the power and/or signal cable 280 electrically connected thereto. In the event that the electronics section 274 is powered by an independent power source and the signal information is transmitted via wireless communication to the display 278 or other device, the cable 280 can be eliminated. As shown, the PCB is preferably connected to the upper surface 296 of the crossbar 290 in such a manner that the PCB is isolated from vibration and bending forces incident on the receiver hitch 272. However, it will be understood that the PCB can be mounted on any surface of the crossbar, within the hollow interior of the crossbar, on any surface of the receiver tube 292, within the hollow interior of the or in the receiver tube, or at any other location on the hitch or towing vehicle without departing from the spirit and scope of the invention.

The electronics section further includes various components and circuitry connected to the PCB, such as shown in FIG. 22 and previously described. A strain gauge 66 is preferably located in a recess 298 formed in the side surface 300 of the receiver tube 292. Likewise, a strain gauge 68 is preferably located in a recess 302 formed in the upper surface 296 of the crossbar 290. Each strain gauge 66 and 68 preferably includes dual element strain sensors, as in the previous embodiments, that are angled at approximately 90 degrees from each other to measure shear stresses in the recesses 298 and 302. Preferably, the strain gauge 66 is oriented vertically, or parallel with the strain axis (with the strain sensors angled at 45 degrees with respect to vertical) to sense the shear stresses in the receiver tube 292 caused by a vertical load on the hitch ball 284, as represented by arrows 304 and 305 in FIG. 23. Likewise, the strain gauge 68 is preferably oriented horizontally, or parallel with the strain axis (with the strain sensors angled at 45 degrees with respect to the fore and aft direction) to sense the shear stresses in the crossbar 290 caused by a horizontal load, and more particularly by fore and aft loads on the hitch ball 284, as represented by arrows 306 and 308 in FIG. 23.

In accordance with another preferred embodiment of the invention, a further strain gauge, such as “SENSOR 3” denoted by numeral 252 in FIG. 22, can be fixedly mounted to the top surface 310 of the receiver tube 292 to measure lateral forces perpendicular to the fore and aft forces acting on the crossbar 290.

As in the previous embodiments, more than one strain gauge can be used for measuring each of the above-mentioned directional forces. By way of example, a further strain gauge 66 can be mounted on the opposite side of the receiver tube 292 while a further strain gauge 68 can be mounted on the lower surface of the crossbar 280. The signals from the strain gauge(s) 66 can be connected in a circuit and sent to the processor 74 (FIG. 22) for determining the vertical force on the hitch ball 26, and thus the tongue weight. Likewise, the signals from the strain gauge(s) 68 can be connected in a circuit and sent to the processor 74 for determining the fore and aft forces on the hitch ball 26, and thus the pulling load of the towed vehicle. The recesses 298 and 302 can be filled with a resilient potting material to protect the strain gauges and their delicate wire leads from harsh environmental conditions.

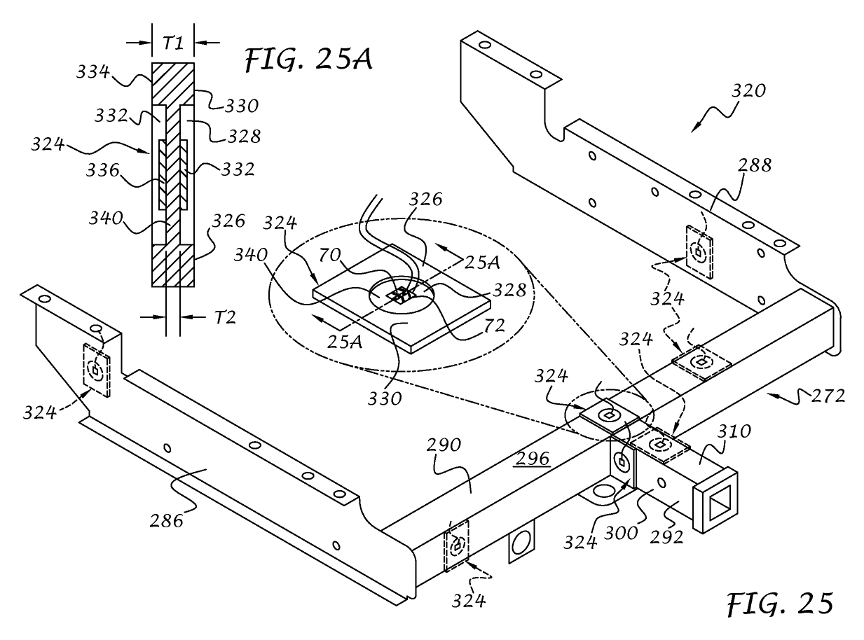

Referring now to FIGS. 25 and 25A, a receiver hitch system 320 in accordance with yet another embodiment of the invention is illustrated. The receiver hitch system 320 is similar in construction to the receiver hitch system 270 previously described, and includes a receiver hitch 322 with one or more strain sensor modules 324 mounted thereto. Each strain sensor assembly 324 preferably includes a sensor mounting plate 326, a first recessed sensor area 328 formed in one face 330 thereof, a second recessed sensor area 332 formed in the opposite face 334 thereof, and strain gauges 336 and 338, preferably similar to the strain gauges previously described, fixedly secured to a center web 340 in their respective recessed sensor areas.

The sensor mounting plate 326 has a first thickness T1 for welding, bonding, fastening, and/or otherwise mounting the strain sensor module at various locations on the receiver hitch 322, as illustrated by the sensor assemblies 24 in both solid an broken lines. The recessed sensor areas 328 and 332 are preferably formed in opposite sides of the mounting plate 326 to create a second thickness T2 which is smaller than the first thickness T1 for maximizing the strain to be measured without compromising the integrity of the receiver hitch 322.

Each strain gauge 336, 338 preferably includes dual element strain sensors 70, 72 that are angled at approximately 90 degrees from each other to measure shear stresses in the center web 340. Preferably, the strain sensor modules are mounted to one of the side surfaces 300 of the receiver tube 292 and the upper surface 296 of the crossbar 290 such that the strain gauges are oriented parallel with their respective strain axes (with the strain sensors 70, 72 angled at 45 degrees with respect to vertical or horizontal) to sense the shear stresses caused by vertical and horizontal loads on the hitch ball 26. However, it will be understood, as mentioned above, that the strain sensor modules can be mounted at any suitable location on the receiver hitch. In accordance with further embodiments of the invention, the modular strain assemblies can be mounted to a drawbar, trailer tongue, and/or other structure that is stressed when towing a vehicle.

The provision of strain sensor modules facilitates manufacture of the receiver hitch since, during assembly, the strain gauges must be permanently bonded to the surface of the material using special epoxy adhesive, application of pressure and heat during the curing process. Due to the relatively small size of the strain sensor module, the plates can be stacked closely together during heat curing in smaller ovens than if the strain gauges were to be directly adhered to the crossbars and receiver tubes prior to assembly of the receiver hitches. Moreover, the modules allow flexibility in material selection and center web thickness to maximize the measurable range of shear forces over the anticipate range of loads that the receiver hitch will be subjected to.

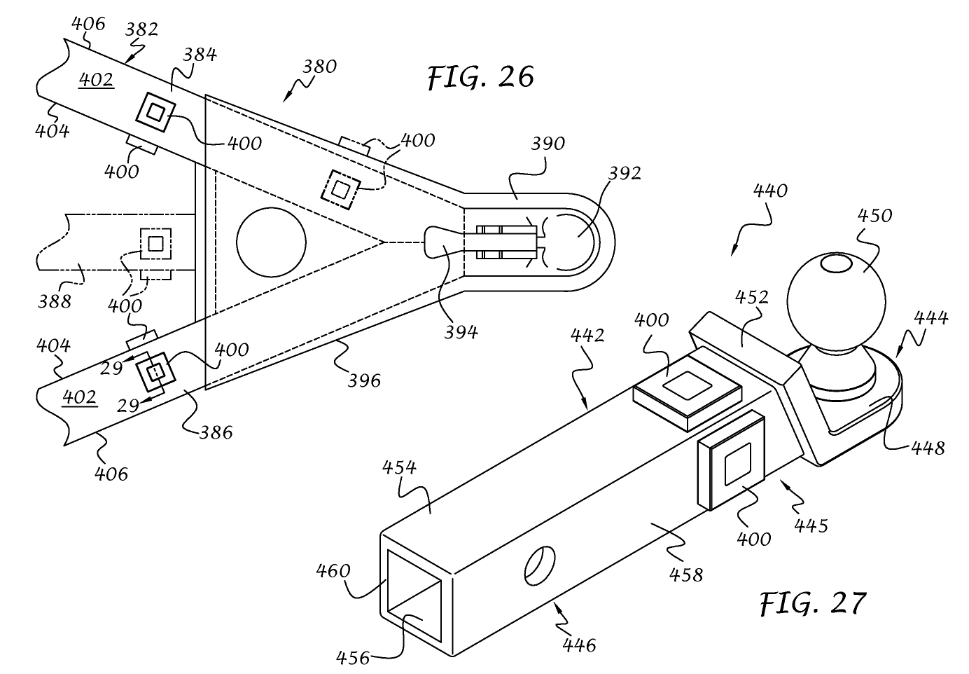

Referring now to FIG. 26, a trailer tongue system 380 in accordance with yet another embodiment of the invention is illustrated. For purposes of describing the invention, the trailer tongue system 380 includes an A-Frame tongue configuration 382. However, it will be understood that the present invention is not limited thereto but includes other tongue configurations such as straight tongues, gooseneck and fifth-wheel mechanisms, and so on. Accordingly, the following description is by way of an exemplary embodiment of the invention only.

The A-Frame tongue configuration 382 preferably includes side support bars 384 and 386 that are connected to the trailer frame (not shown) and converge toward a coupler 390 that is securely connected to the side bars in a well-known manner. A center support bar 388 (shown in phantom line) is also typical in many A-Frame trailer tongues.

The coupler 390 typically has a socket portion 392 that receives a hitch ball (not shown in FIG. 26) associated with a drawbar or the like and an extension portion 396 that extends rearwardly from the socket portion. The extension portion is shaped to accommodate the geometrical configuration of the support bars 384 and 386. The coupler is typically mounted to the side support bars 384, 386 and other support structure through fasteners or welding. A latch 394 is operably associated with the socket portion 392 in a well-known manner to lock the trailer tongue to the hitch ball when the trailer is properly hitched to a tow vehicle. The trailer tongue system 380 also preferably includes one or more strain sensor modules 400 mounted to the top surface 402 (or bottom surface) and one of the side surfaces 404, 406 of each side support bar 384, 386 for measuring the strain on the trailer tongue. Each module is preferably constructed of a material that is similar to the trailer tongue and is mounted thereto through well-known connection means such as welding, adhesive bonding, mechanical fastening, or combinations thereof. However, it will be understood that each module can be constructed of other materials and fastened by other means without departing from the spirit and scope of the invention.

In accordance with a further embodiment of the invention, one or more strain sensor modules 400 can be mounted to the top or side surfaces of the coupler 390, as shown in phantom line. It will be understood therefore that the modules can be placed at any location on the trailer tongue where strain can be measured for determining various towing conditions.

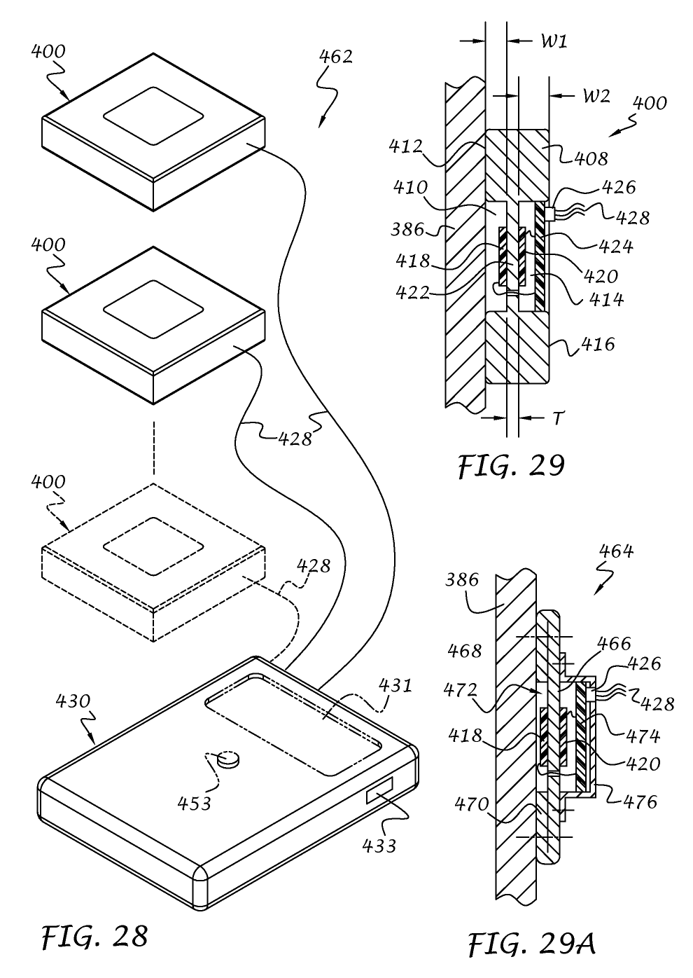

With additional reference to FIG. 29, each strain sensor module 400 is somewhat similar in construction to the strain sensor module 324 previously described, and preferably includes a sensor mounting plate 408, a first recessed sensor area 410 formed in one face 412 thereof, a second recessed sensor area 414 formed in the opposite face 416 thereof, and strain gauges 418 and 420, preferably similar to the strain gauges previously described, fixedly secured to a center web 422 in their respective recessed sensor areas. A printed circuit board (PCB) 424 is preferably located in one of the recessed sensor areas, such as area 414, and is electrically connected to the strain gauges. The PCB can include electronic circuitry and components, such as a processor, amplifier, signal conditioning circuitry, and so on, for processing the signals from the strain gauges to minimize signal loss and electrical interference that might otherwise occur if the processor were to be located further away from the strain gauges. A connector 426 is also preferably mounted to the PCB with an electrical cable assembly 428 extending therefrom for providing power to the module 400 and sending signals reflective of the strain measurement to a processing module 430 (FIG. 28) for further signal processing and transmittal to a display device, such as a smartphone or other display, as previously described. As shown, a width W1 of the first recessed sensor area 410 is preferably less than a width W2 of the second recessed sensor area 414 so that the center web 422 is as close as possible to the surface of the beam structure 386. In addition, the thickness T of the center web 422 can be varied depending on the material used to construct the module and the bandwidth of strain measurement needed to obtain the desired accuracy, as in the previous embodiments.

In accordance with a further embodiment of the invention, the strain sensor module can be battery-powered and can have a transceiver for wirelessly transmitting the signal data to the communications unit 428 to thereby eliminate the connector 426 and electrical cable assembly 428.

Referring now to FIG. 27, a drawbar transducer 440 in accordance with a further embodiment of the invention is illustrated. The drawbar transducer 440 preferably includes a body 442 with a forward coupling section 444, a sensing section 445, and a rear mounting section 446. The forward coupling section 444 preferably includes a platform 448 that extends forwardly from the sensing section 445 and an opening (not shown) that extends through the platform 448 for receiving the shank of a hitch ball 450 in a well-known manner. An inclined wall 452 extends upwardly and rearwardly from the platform 448 to provide clearance for the hitch ball 450 and trailer tongue (not shown in FIG. 27) when coupled to the hitch ball. It will be understood that the coupling section 444 is not limited to a hitch ball arrangement but may be configured to accommodate any coupling requirement of the towed vehicle.

The intermediate sensing section 445 and rear mounting section 446 are preferably of hollow tubular construction and defined by a top wall 454, bottom wall 456, and side walls 458 and 460 that extend between the top and bottom walls. One or more strain sensor modules 400, as previously described, are preferably mounted to the top surface 454 (and/or bottom surface 456) and one or both of the side surfaces 458, 460 of the sensing section 445 for measuring the strain on the drawbar transducer 440. Each module 400 is preferably constructed of a material that is similar to the drawbar and is mounted thereto through well-known connection means such as welding, adhesive bonding, mechanical fastening, or combinations thereof. However, it will be understood that each module can be constructed of other materials and fastened by other means without departing from the spirit and scope of the invention. Moreover, it will be understood that the drawbar transducer can be of solid construction. It will be further understood that the modules can be placed at any location on the drawbar transducer where strain can be measured for determining various towing conditions.

As shown in FIG. 28, an adaptor kit 462 for installation on a receiver hitch, trailer tongue, drawbar, or other towing structure subjected to variable strain under pulling and loading conditions is illustrated. The adaptor kit 462 preferably includes one or more strain sensor modules 400 and a processing module 430 operably connected to the or each strain sensor module 400. The processing module 430 preferably incorporates similar circuitry and components as illustrated in FIG. 22. and can include an optional display 431 (shown in phantom line) and a USB-type connection 433 or the like for interfacing with an authorized client computer or processor to download stored data reflective of recorded towing parameters for warranty and/or liability claims. A power switch 435 can also be included for turning the processing module 430 on and off. The sensor modules 400 and processing module 430 can be connected via a hard wire connection, as illustrated by cables 428, or can be wirelessly connected together through wireless transceivers or the like, as described with respect to previous embodiments. When the sensor modules are hard wired to the processing module, the cables 428 can include power, ground and signal electrical conductors. With this arrangement, the processing module can provide electrical power to the or each sensor module and receive strain signals from the or each sensor module. When the sensor modules are wirelessly connected with the processing module, the sensor modules preferably have their own power source.

During installation of the adaptor kit 462, the sensor modules 400 are located at appropriate positions on the receiver hitch, trailer tongue, or drawbar, as previously shown and described, for measuring strain associated with loading the trailer and towing such as the trailer tongue weight, towing forces, load balance from side to side and front to back, and so on. The processing module 430 is also located in a position where acceleration, velocity, tilt, etc., of the tow vehicle and/or trailer can be monitored to obtain information that will aid the user in both loading the trailer and towing. In addition, such information can be recorded and recalled to help the manufacturer to provide a safer tow experience to the user, reduce warranty claims in the event the user exceeds the tow limits of the vehicle, hitch, trailer, and so on, as well as to reduce the liability associated with user error during loading and towing.

Referring now to FIG. 29A, a strain sensor module 464 in accordance with a further embodiment of the invention is illustrated. The strain sensor module 464 can be used in conjunction with the adaptor kit 462 in place of or supplemental to the sensor modules 400 previously described, for attachment to receiver hitches, drawbars, trailer tongues, or other load bearing structures.

As shown, the strain sensor module 464 preferably includes a sensor mounting plate 466 formed of a sheet material with opposing ends 468, 470 bent over to form a recessed sensor area 472. A first strain gauge 418 is fixedly secured to one side of the sheet material 466 in the recessed sensor area 472 and a second strain gage 420 is fixedly secured to the opposite side of the sheet material. A PCB 474 is preferably located in a cap 476 which is in turn connected to the sheet material 466 through fastening, adhesive bonding, welding, or other connection means. As in the previous sensor module embodiment, the PCB 474 can include electronic circuitry and components, such as a processor, amplifier, signal conditioning circuitry, and so on, for processing the signals from the strain gauges to minimize signal loss and electrical interference that might otherwise occur if the processor were to be located further away from the strain gauges. A connector 426 is also preferably mounted to the PCB with an electrical cable assembly 428 extending therefrom for providing power to the module 400 and sending signals reflective of the strain measurement to the processing module 430 (FIG. 28) for further signal processing and transmittal to a display device, such as a smartphone or other display, as previously described. The thickness of the sheet material 466 can be varied depending on the material used to construct the module and the bandwidth of strain measurement needed to obtain the desired accuracy, as in the previous embodiments.

In accordance with a further embodiment of the invention, the strain sensor module 464 can be battery-powered and can have a transceiver for wirelessly transmitting the signal data to the communications unit 430 to thereby eliminate the connector 426 and electrical cable assembly 428.

The strain sensor module 464 is preferably fixedly secured to the structure that undergoes strain during loading and/or towing as previously described by any suitable connecting means such as adhesive bonding, mechanical fastening, welding, or combinations thereof. In accordance with the invention, the strain sensor modules in each of the above embodiments can additionally or alternatively be installed in cut-out sections of the hitch, trailer tongue, drawbar, or other tow structure through welding or other connecting means.

Due to variations inherent in manufacturing and installing the strain gauges and/or sensor modules 324, 400 or 464, the adaptor kit may need to be calibrated after installation for obtaining the desired accuracy. For example, variations in the placement of the sensor modules from one hitch to another or variations in the placement of the strain gauges in the sensor modules may cause the trailer tongue weight and other parameters to vary from installation to installation. Accordingly, it is contemplated that a calibration routine and/or equipment associated with the calibration routine can be customized for each type of installation so that an applied force or range of forces on a trailer tongue, for example, will produce a strain signal that can be associated with that applied force. Such force/strain relationships can be stored in a look-up table associated with memory 262 (FIG. 22) so that a strain signal generated after calibration will result in the appropriate tongue weight or other forces being displayed and manipulated for other calculations. Linear and/or non-linear formulas can also or alternatively be used for ensuring that a generated strain signal results in the correct force component.

Although each of the above strain sensor module embodiments preferably include two strain gauges mounted on opposing sides of a central web or sheet, it will be understood that a single strain gauge or more than two strain gauges or similar sensors can be used and/or mounted at different locations without departing from the spirit and scope of the invention.

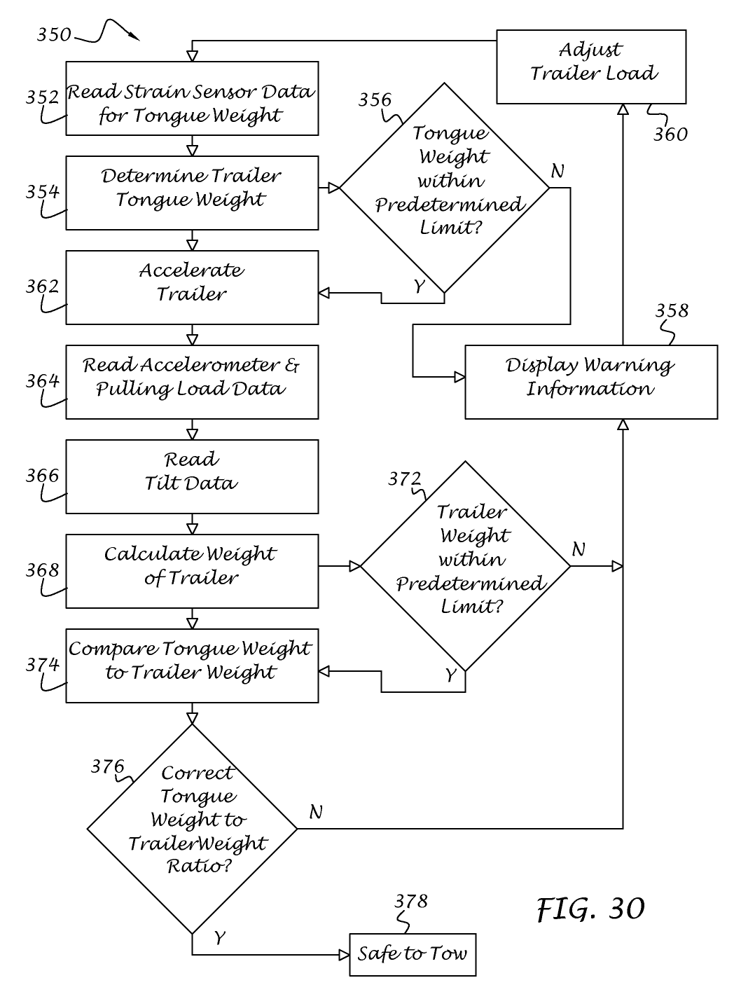

Referring now to FIG. 30, a method 350 for determining a safe towing condition of a trailer or other vehicle to be towed with the hitch system of the present invention is illustrated, whether it be associated with the drawbar transducer systems of the previous embodiments, the above-described receiver hitch system, the above-described trailer tongue system, or other towing structure. At block 352, the strain sensor data associated with the trailer tongue weight is read by the processor. At block 354, the trailer tongue weight is determined based on the strain sensor data. At block 356, it is determined if the tongue weight is within the maximum safe load for the tow vehicle. If not, warning information is displayed at 358 and the user is instructed to adjust the load at block 360. The warning information as well as other data can be communicated via Bluetooth or other wireless transmission means to a smartphone, smartpad, wirelessly to a display device, and/or via hardwire to a vehicle console or the like where other information can be displayed, such as is commonly practiced including but not limited to location based on GPS signals, trip information, and so on.

If at block 356 it is determined that the trailer tongue weight is within the maximum safe load for the tow vehicle, at block 362 the user is instructed to drive the trailer, preferably in a forward direction, for a short distance. At block 364, the acceleration and/or deceleration data associated with movement of the towed vehicle is read, along with strain sensor data associated with the fore and aft (pulling forces) present on the drawbar transducer, receiver hitch, and/or trailer tongue. In most cases, the acceleration data can be gathered very quickly so that the travel distance to obtain the acceleration data will be relatively short, on the order of a few feet, and the travel speed will be relatively low, such that obtaining the acceleration and pulling force readings will be relatively quick. The display, an audible signal, or other means can be used to notify a user when to start and/or stop the tow vehicle with attached trailer. At block 366, tilt data from the tilt sensor 258 (FIG. 22) can be used for accommodating both trailer tongue weight calculations and trailer weight calculations when the trailer is on an inclined surface.

At block 368, the weight of the trailer, whether empty or loaded, is calculated. This is possible based on the instantaneous (or average) acceleration as measured by the accelerometer and the instantaneous (or average) fore and aft load on the receiver hitch (or draw bar) as measured by the strain sensors in accordance with the following formula:

F=m×A (1)

Where F is the pulling force, m is the mass of the towed vehicle, and A is the acceleration of the towed or towing vehicle in the pulling force direction. Since the pulling force F is known from one or more of the strain sensors as previously described, such as strain gauge 332, and/or 334 located on the upper surface 296 of the crossbar 290, and further since the acceleration is known from the accelerometer 256 (FIG. 22), the mass of the towed vehicle can be calculated as follows:

$$m = \frac{A}{F} \qquad ( 2 )$$

Once the mass of the towed vehicle has been determined, the gross weight of the towed vehicle can be calculated as follows:

$$W = m \times g or W = \frac{A}{F} \times g \qquad ( 3 )$$

Where W is the weight of the towed vehicle, m is the mass of the towed vehicle, and g is the gravitational constant. If needed, the mass or weight of the towing vehicle can be predetermined and factored out before determining the weight W of the trailer. When the mass or weight of the tow vehicle is a factor, then the Gross Combination Weight (GCW), the combined actual weight of the tow vehicle and towed vehicle can be calculated and compared to the tow vehicle's Gross Combination Weight Rating (GCWR), which is the safe combined weight of the tow vehicle and trailer, the passengers, luggage, equipment, and other items. If the GCWR is exceeded, then the vehicle's engine, transmission, brakes, and so forth can become stressed beyond their design limits and void new vehicle warranty.

The weight of the trailer can be constantly monitored during towing, factoring out variations in road and travel conditions as described above. If the weight of the trailer changes beyond a predetermined delta factor, such as when a portion of the load has been lost, then the user is alerted to investigate the problem.

If the towing vehicle and towed vehicle are traveling up or down a sloped road surface, the tilt sensors 258 (FIG. 22) and/or the accelerometer 256 can be used to detect the amount of slope and adjust both the calculated gross trailer weight and the tongue weight of the towed vehicle by factoring out the gravitational component of the pulling force as follows:

W=m×g sin θ (4)

Where θ is the slope of the road surface as measured by the tilt sensor or accelerometer. Since

$$m = \frac{A}{F}$$

according to equation (2) above, then:

$$W = \frac{A}{F} \times g sin θ \qquad ( 5 )$$

In this manner, the gross weight of the trailer or other towed vehicle can be determined quickly and accurately without the necessity of traveling to a publicly accessible scale to determine whether or not the towed vehicle is overloaded or the load is unbalanced or that the tongue weight and/or towing capacity of the towing vehicle have been exceeded. Thus, the present invention eliminates the need for a costly and cumbersome weight scale for determining the weight of the towed vehicle. Accordingly, the operator need only step on the accelerator then step on the brake to have the gross trailer weight displayed. The trailer would only have to move a few feet to have enough information to calculate the weight.

Once the trailer weight has been calculated, it is determined at block 372 whether or not the trailer weight exceeds the towing capacity of the tow vehicle as predetermined by the vehicle manufacturer. If the towing capacity has been exceeded, then a warning to that effect is displayed at block 358 and the user is prompted to adjust the trailer load. If at block 372 the trailer weight is within the towing capacity of the tow vehicle, the ratio of the tongue weight to the trailer weight can be calculated, as shown at block 374. If at block 376 the ratio of tongue weight to trailer weight is within a predetermined ratio or ratio range, such as 10% to 15%, the display can inform the user, at block 378, that the trailer is safely loaded for towing. If however the tongue weight to trailer weight ratio is below or above the predetermined ratio or ratio range, then a warning to that effect is displayed at block 358 and the user is prompted to shift the load at block 360 until the proper ratio has been achieved. At this point, since the trailer weight has already been calculated and determined to be within the towing capacity of the tow vehicle, then the user need only shift the load on the trailer, either forward or aft, until the ratio is within the predetermined ratio range.

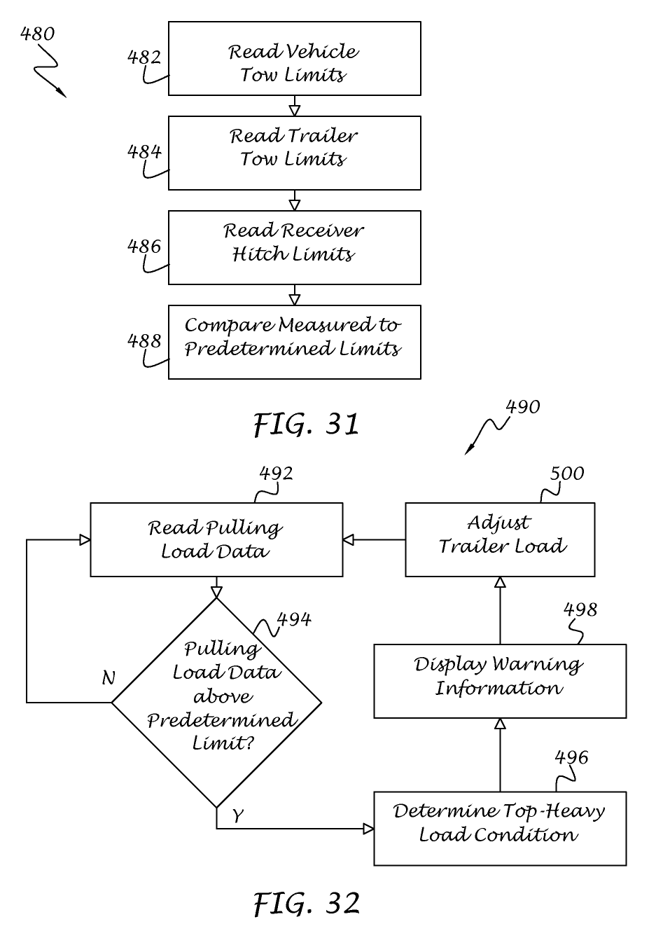

Referring now to FIG. 31, a method 480 is illustrated for determining whether or not a loaded trailer or other vehicle to be towed with the hitch system of the present invention is within predefined limits for blocks 356 and 372 of FIG. 30. As shown at block 482, the towing limit of a particular tow vehicle is read, e.g. a memory location storing the towing limit of the tow vehicle is accessed. At block 484, the towing limit of a particular trailer or the like is read. At block 486, the towing limits of a receiver hitch, ball mount, and other structure associated with the hitch is read. These predetermined limits can be entered by a user or service person during initial setup prior to loading the vehicle, as will be described in further detail below. In accordance with a further embodiment of the invention, where a tow package is supplied with a tow vehicle, the vehicle and hitch parameters can be a permanent part of the system prior to delivery of the vehicle to a customer. After the predetermined limits are read or accessed, they are compared to the measured parameters of the vehicle, hitch and trailer at block 488.

Referring now to FIG. 32, a method 490 for determining a top-heavy load condition of a trailer is illustrated. At block 492, the load data associated with pulling a trailer is acquired during the acceleration step 362 in FIG. 30. At block 494, it is determined if the measured pulling load has a vertical component above a predetermined threshold. If so, a top-heavy condition of the contents on the trailer is determined at block 496. A top-heavy condition raises the center of gravity of the trailer, which can result in loss of control or other unanticipated difficulties while towing. If a top-heavy condition is determined, a warning is generated at block 498, which can include audible and visual indications. At block 500, the user is instructed to adjust the load prior to towing. A further check of the top-heavy condition can then be made prior to towing by accelerating the trailer again.

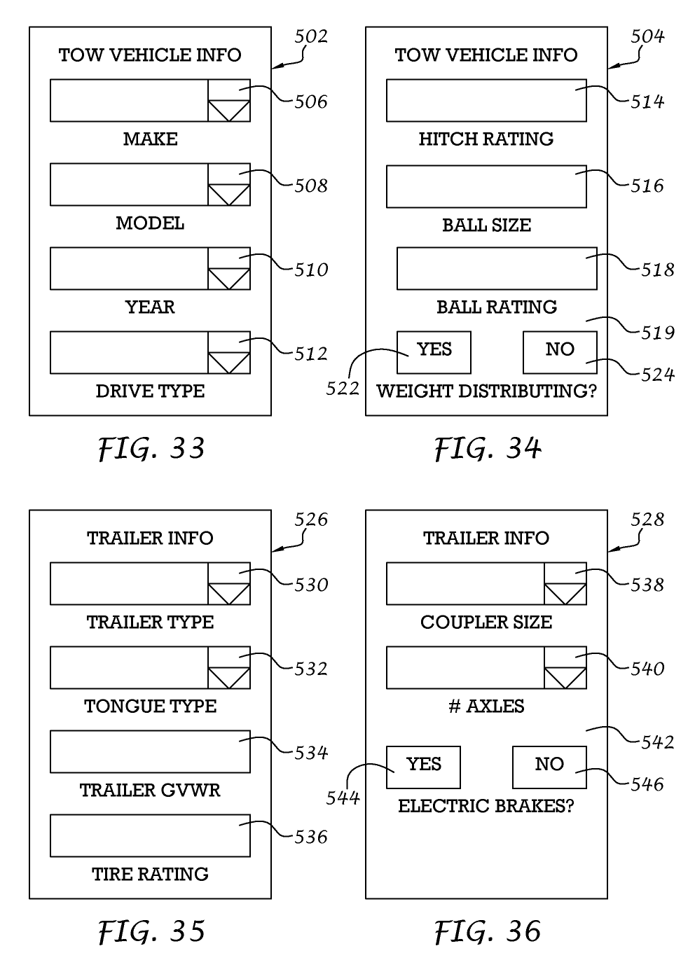

Referring now to FIGS. 33-43, exemplary screen shots of an interactive user interface and its associated software that forms part of the system and method for gauging safe towing conditions is illustrated. The screen shots are preferably implemented on a system having a touch-screen display, such as a smartphone, smartpad, computer, and so on, using any type of operating system in use or to be developed in the future. However, it will be understood that the interactive user interface and its associated software can be implemented in other systems with displays that do not have the touch-screen feature.

As shown in FIGS. 33 and 34, prior to towing a trailer or other towed vehicle, information relating to the tow vehicle and its hitch system is entered by the user, installer, or other person on screens 502 and 504, respectively. As shown in FIG. 33, a drop-box 506 can be touched by a user to gain access to a list of vehicle makes. A drop-box 508 can likewise be accessed to gain access to a list of vehicle models for a particular make. The model year of the tow vehicle can also be accessed at the drop-box 510. Finally, the drive type of the vehicle can be accessed at drop-box 512, which may include front-wheel drive, rear-wheel drive, all-wheel drive, and four-wheel drive. Other information to be entered can include, but is not limited to, the suspension type, engine size, and so on (not shown) that may have been offered as options by the original equipment manufacturer (OEM). The information entered is communicated with the processor 74 (FIG. 22) or the like for determining the trailer weight towing limit of the tow vehicle as specified by the OEM.

As shown in FIG. 34, information relating to the hitch system is entered. At drop-box 514, for example, the hitch type or rating is selected, which may include Class I, II, III, IV, or V for most applications. At drop-box 516, the ball size is selected from a list of standard ball sizes, which may include, but is not limited to, 1⅞″, 2″ and 2 5/16″. At drop-box 518, a rating of the ball size can also be selected or alternatively entered if such information is available on the hitch ball. If this information is not entered, the default rating associated with each ball size is used. At section 520, the user is asked whether or not a weight distributing hitch will be used. The user presses either the “YES” button 522 or the “NO” button 524. Other information to be entered may include, but is not limited to, whether the hitch is rear-mounted or front-mounted or if the hitch is of special configuration. As an alternative to drop-boxes in one or more of the screen shots, the information can be manually entered on a keyboard or the like by a user.

As shown in FIGS. 35 and 36, information relating to the trailer is entered at screen shots 526 and 528, respectively. At drop-box 530, a trailer type is selected from a list of trailer types. For example, trailer types may include, but are not limited to, travel trailer, utility trailer, car hauler, motorcycle trailer, horse trailer, boat trailer, camper, and so on. At drop-box 532, the trailer tongue type is selected from a list of tongue types including, but not limited to, A-Frame, straight, fold-away, and so on. At box 534, the trailer gross vehicle weight rating (GVWR) or maximum loaded trailer weight is entered by keyboard or other input device. This information can usually be found on a manufacturer's label attached to the trailer. At box 536, the maximum weight of the trailer tire is entered. This information can usually be found on a sidewall of the tire. Although the trailer itself may be designed to carry a predefined maximum load, the tire rating is preferably taken into account to determine the maximum safe load since an inferior tire installed on a heavy-duty suspension may reduce the safe load capacity of the trailer. At drop-box 538 in FIG. 36, the coupler size can be selected from a list, which may include, but is not limited to, 1⅞″, 2″ and 2 5/16″. The redundant information relating to the coupler size and ball size entered above is cross-checked to make sure the ball and coupler size match. If a mismatch occurs, the user is informed of the discrepancy and is instructed to replace the hitch ball with the correct size to match the coupler. At drop-box 540, the number of axles on the trailer is selected from a list which may include one, two, or three axles for most trailer configurations. At section 542, the user is asked whether or not the trailer is equipped with electric brakes. The user presses either the “YES” button 544 or the “NO” button 546.

Once the tow vehicle, hitch, and trailer information has been entered, the information can be stored in a memory of the smart device, display device or the like for retrieval at a later date when the same towing combination will be used. The stored data is also used to determine a safe towing condition and monitor various parameters during loading and towing.

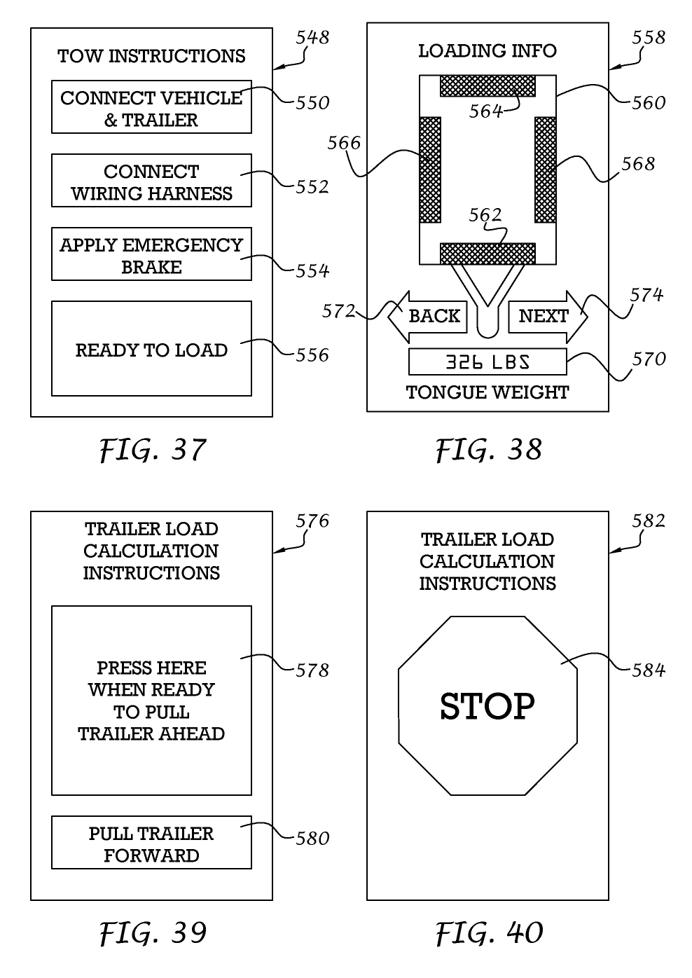

Referring now to FIG. 37, an exemplary screen shot 548 listing various tow instructions is shown. At button 548, the user is instructed to connect the vehicle to the trailer. This can include further instructions and/or icons, video or the like to show the correct procedure in connecting the vehicles together. A dynamic instruction routine can be assembled using the information previously entered to customize the instructions for a particular combination of equipment. Those instructions can include connecting the wiring harness at button 552, applying the tow vehicle's emergency brake at button 554, connecting the safety chains (not shown), and so on. After each instruction is completed, the buttons can be pressed, thereby changing an appearance of the button and highlighting the next instruction button. In this manner, users with little or no experience as well as the seasoned tower can confidently connect the tow vehicle to the trailer, properly load the trailer, and tow with a degree of confidence heretofore unknown in the towing industry.

When the “READY TO LOAD” button 556 is pressed or otherwise accessed, a screen shot 558 of a generic trailer image or icon 560 is shown in FIG. 28. The trailer icon 560 is shown with a front indicator bar 562, a rear indicator bar 564, a left (passenger) side indicator bar 566, and a right (driver) side indicator bar 568. During trailer loading, the bars may alternate between visually different states, such as red and green by way of example, to indicate if the trailer is properly balanced from front to rear and from side to side. If, for example, the right side indicator bar is red, then the user is notified that the trailer is improperly balanced from side to side, i.e. the load on the right side of the trailer is greater than the load on the left side of the trailer above a predetermined delta. If, for example, the front indicator bar 562 is red, then the user is notified that the tongue weight is too heavy for the predefined tow limits of the vehicle, hitch, and drawbar. When all four bars are green, for example, the user is notified that the trailer is properly balanced from front to rear and from side to side. It will be understood that the indicators are not limited to color-changing bars or icons but can include flashing indicators, audible indicators, alpha-numeric indicators, and so on, as long as a visual and/or audible distinction can be made between a balanced load and an imbalanced load. An information box 570 is preferably located below the trailer icon 560 for displaying the dynamic tongue weight of the trailer during loading. In this manner, the user can quickly determine if the tongue weight is within the weight rating of the drawbar, hitch ball, and receiver hitch, and/or other hitch structure. A “BACK” button 572 and a “NEXT” button 574 can be part of one or more screen shots to enable a user to go backward and forward for changing information related to the tow vehicle, trailer, hitch, and so on, and/or to repeat the instructional steps previously described. In accordance with a further embodiment of the invention, the user can additionally or alternatively scroll forward and reverse through all or a limited number of screen shots by detecting a stroking movement of the user's finger when a touch-screen device is used.

Once the trailer is loaded, the next screen 576, as shown in FIG. 39, is preferably accessed. This screen shot shows a large button 578 to be pressed. When the button is activated, an instruction box 580 preferably appears to instruct the user to pull the tow vehicle and trailer forward. As the trailer is pulled forward (or backward), various parameters of the tow system are measured, such as acceleration, pulling force, tongue weight, tilt or inclination, and so on, as previously described.

Once stable measurement data is collected, the screen 582 appears, as shown in FIG. 40, instructing the user to stop the tow vehicle and trailer, as represented by the stop sign icon 584. Deceleration data can be collected during the stopping operation to obtain additional measurement data.

When it is detected by the accelerometer that the trailer has stopped, the screen 586 appears shown the measured and calculated data. For example, information box 588 preferably shows the calculated trailer weight, as described above, information box 590 preferably displays the tongue weight as measured, and information boxy 592 displays the percent tongue weight to trailer weight.

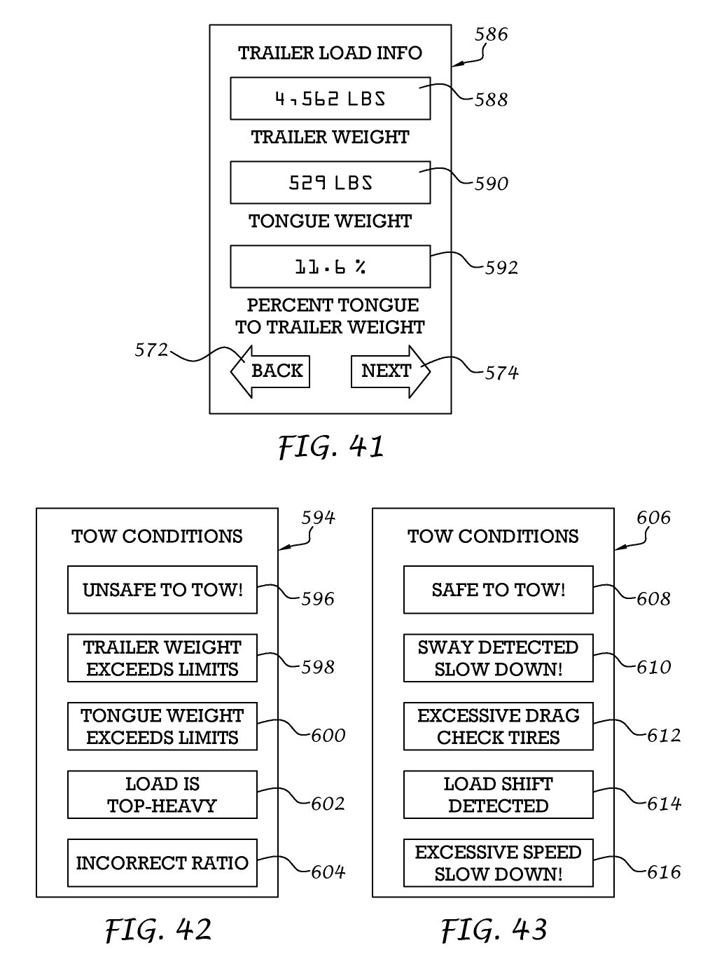

Many manufacturers recommend a 10% to 15% ratio in order to safely tow a trailer. If the ratio is not within the predetermined recommended safe range, or if it is determined that other factors would result in an unsafe towing condition, then the user is notified at box 596, as shown by way of example at screen 594 in FIG. 42. Other unsafe conditions can be displayed, such as shown at button 598 where it has been determined that the trailer weight exceeds the towing capacity of the vehicle, the hitch, the drawbar, the trailer, and/or other towing structure. At button 600, the user can be notified that the tongue weight exceeds the predetermined limits. At button 602, the user can be notified that the load is top-heavy in the trailer, as previously described. At button 604, the user is notified that the percent tongue weight to trailer weight is incorrect. The above unsafe towing conditions are given by way of example only and are not intended to be an exhaustive list. In addition when only one unsafe condition exists, only that button or icon need be shown. When the button is pressed by a user or otherwise actuated, a further display screen (not shown) can show the details of the unsafe towing condition. For example, if the trailer weight exceeds the rated towing capacity of the tow vehicle, a screen can show the calculated trailer weight, the towing capacity of the tow vehicle, and the difference therebetween.

If all factors indicate a safe towing condition, then the screen 606 preferably appears, indicating the safe tow condition at information box 608. During towing, various measurements are made, including acceleration in multiple axes, tilt, tow force, and various conditions are determined such as a potential or actual trailer sway condition at box 610 where the user is instructed to slow down, an excessive drag condition at box 612, such as when the average tow force increases over time, factoring out vehicle speed and tilt, so that the user can be informed of a possible malfunction in the trailer such as low tire pressure, worn wheel bearings, or other conditions that may increase the pulling force. At box 614, a load shift can be detected to inform an operator that a potentially unsafe towing condition has occurred. At box 166, the user is informed that the tow vehicle and trailer are traveling at a speed above the recommended safe speed for the trailer and/or tow vehicle. The maximum safe speed can be present by the manufacturer or calculated based on the particular tow vehicle, trailer and hitch combination. Other factors that can change the maximum safe tow velocity can include road roughness as detected by the accelerometer, the downward slope of a road surface for a given trailer weight (to prevent brake failure due to hard braking caused by excessive downhill speed for example).

Data reflective of unsafe towing conditions can be stored in a memory device, including excessive trailer weight, tongue weight, excessive speed, imbalanced load, incorrect tongue to trailer ratio, and so on, and retrieved by an authorized user to determine if warranty limits have been exceeded as well as factors relating to liability.

It will be understood that the various measured and calculated parameters as described above are given by way of example only and are not intended to be an exhaustive list. It will be further understood that the various screen shots are given by way of example only and are not intended to to limit the invention.

The software techniques and methods discussed above can be implemented in digital electronic circuitry, or in computer hardware, firmware, software, or combinations thereof. Apparatus may be implemented in a computer program product tangibly embodied in a machine-readable storage device for execution by a programmable processor; and the above-described methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from and transmit data and instructions to a data storage system, at least one input device, and at least one output device. Each computer program may be implemented in a high level procedural or object-oriented programming language, or in assembly or machine language, which can be compiled or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

Prior to the present invention and its many advantages as disclosed above and many more which will become apparent from the present disclosure, virtually the only way to measure the trailer weight was to tow the trailer to a public scale (such as at a landfill or truck stop), which could be dangerous in and of itself if the trailer is improperly loaded to begin with. Thus, with the trailer weight and trailer tongue weight known, and with such information stored in memory for later retrieval when determining if repairs to the vehicle are covered under warranty, vehicle manufacturers would be able to quantify with reasonable accuracy whether or not the towing capacity of the vehicle has been exceeded and void the warranty where abuse from the customer has occurred, or to even protect the vehicle manufacturer in the event of a lawsuit where injury or loss of property has occurred due to improper loading and/or towing.

It will be understood that terms of orientation and/or position such as upper, lower, vertical, horizontal, front, rear, and so on, relate to relative rather than absolute orientations and/or positions.

It will be appreciated by those skilled in the art that changes could be made to the embodiments described above without departing from the broad inventive concept thereof. It will be understood, therefore, that this invention is not limited to the particular embodiments disclosed, but it is intended to cover modifications within the spirit and scope of the present invention as defined by the appended claims.

I claim:

1. A sensor kit for detecting and analyzing loading and towing conditions of a trailer with respect to a tow vehicle, the sensor kit comprising:
a first sensor module having a first force sensor for sensing a pull force of the trailer; and
a processing module operably connectable to the first sensor module for receiving first data related to the pull force and including means for calculating a weight of the trailer and communicating the weight calculation to a user.

2. A sensor kit for detecting and analyzing loading and towing conditions of a trailer according to claim 1, and further comprising:
a second sensor module having a second force sensor for sensing a tongue weight of the trailer;
the processing module being operably connectable to the second sensor module for receiving second data related to the tongue weight and including means for calculating a ratio of the tongue weight to the trailer weight and communicating the ratio to a user.

3. A sensor kit for detecting and analyzing loading and towing conditions of a trailer according to claim 2, and further comprising:
a third sensor module having a third force sensor for sensing a pull force of the trailer in conjunction with the first sensor module;
the processing module being operably connectable to the third sensor module for receiving third data related to the pull force and including means for calculating a side to side balance condition of the trailer based on the first and third data and means for communicating the balance condition to a user.

4. A sensor kit for detecting and analyzing loading and towing conditions of a trailer according to claim 2, wherein the processing module further comprises means for determining a sway condition of the trailer during towing.

5. A trailer tongue comprising the sensor kit of claim 2, the trailer tongue comprising a first load bearing member;
wherein the first sensor module is securely connected to the first load bearing member along a first plane and the second sensor module is connected to the trailer tongue along a second plane transverse to the first plane.

6. A system for monitoring and calculating loading and towing conditions of a trailer, the system comprising:
means for storing tow vehicle information;
means for storing trailer information;
means for monitoring trailer tongue weight and total trailer weight during loading and towing;
means for comparing the trailer tongue weight and total trailer weight to the stored tow vehicle information and stored trailer information; and
means for indicating a safe or unsafe tow condition based on the comparing means.

7. A system according to claim 6, and further comprising means for detecting an imbalance condition of the trailer at least during loading.

8. A system according to claim 39, and further comprising means for detecting at least one of excessive drag and excessive speed of the trailer during towing.

9. A system according to claim 6, and further comprising means for visually communicating a balance condition of the trailer to a user.

10. A system according to claim 6, and further comprising means for instructing a user to pull the trailer forward and stop the trailer to thereby calculate a total weight of the trailer.
